(19) United States
(12) Patent Application Publication
(10) Pub. No.: US 2021/0389569 A1
(43) Pub. Date: Dec. 16, 2021

(54) SIX-PIECE OPTICAL LENS SYSTEM WITH A WIDE FIELD OF VIEW

(71) Applicant: NEWMAX TECHNOLOGY CO., LTD., Taichung City (TW)

(72) Inventor: Chun-Sheng LEE, TAICHUNG CITY (TW)

(21) Appl. No.: 17/023,349

(22) Filed: Sep. 16, 2020

(30) Foreign Application Priority Data
Jun. 11, 2020 (TW) 109119616

(51) Int. Cl. G02B 13/00; G02B 9/62; G02B 13/06

(52) U.S. Cl. CPC G02B 13/0045; G02B 13/06; G02B 9/62

(57) ABSTRACT

A six-piece optical lens system with a wide field of view includes, in order from the object side to the image side: a first lens element with a negative refractive power, a stop, a second lens element with a positive refractive power, a third lens element with a negative refractive power, a fourth lens element with a positive refractive power, a fifth lens element with a positive refractive power, and a sixth lens element with a negative refractive power, wherein central thicknesses of the first, third, fourth, fifth and sixth lens elements along the optical axis are CT1,CT3,CT4,CT5,CT6, respectively, satisfying the relations: 2.07<(CT1+CT6)/CT3<5.52; 0.82<(CT4+CT5)/(CT1+CT3+CT6)<1.96. Such arrangements can provide a six-piece optical lens system which has a wide field of view, high resolution, short length and less distortion taking into account lens production.

### BACKGROUND

### Field of the Invention

The present invention relates to a six-piece optical lens system with a wide field of view, and more particularly to a miniaturized six-piece optical lens system with a wide field of view which is applicable to electronic products.

### Description of the Prior Art

In recent years, with the popularity of electronic products with the function of taking photographs, there's an increasing demand for an optical lens system. In order to obtain a wider shooting range, the lens angle should meet certain requirements. The field of view of the lens is usually designed to be 50 to 60 degrees, if over the above design angle, the aberration is larger and the lens design is more complex. For example, the optical lens systems as disclosed in U.S. Pat. Nos. 8,335,043 and 8,576,497 use two lens groups and 5-6 pieces of lens elements to obtain a wide field of view, however, their distortion is increased. The optical lens systems as disclosed in U.S. Pat. Nos. 8,593,737, 8,576,497 and 8,395,853 also have a wide field of view, but their TL (total length) of the entire optical lens system is too long.

Therefore, how to develop a miniaturized six-piece optical lens system with a wide field of view which not only can be applied to lenses of the electronic products, such as, digital camera, Webcam, mobile phone and so on, but also has a wide field of view, high resolution, short length and less distortion taking into account lens production is the motivation of the present invention.

The present invention mitigates and/or obviates the aforementioned disadvantages.

### SUMMARY

The primary objective of the present invention is to provide a six-piece optical lens system which has a wide field of view, high resolution, short length and less distortion taking into account lens production.

Therefore, a six-piece optical lens system with a wide field of view in accordance with the present invention comprises a stop and a lens group having six lens elements, in order from an object side to an image side: a first lens element with a negative refractive power having an object-side surface being concave near an optical axis and an image-side surface being concave near the optical axis, at least one of the object-side surface and the image-side surface of the first lens element being aspheric; the stop; a second lens element with a positive refractive power having an object-side surface being convex near the optical axis and an image-side surface being convex near the optical axis, at least one of the object-side surface and the image-side surface of the second lens element being aspheric; a third lens element with a negative refractive power having an object-side surface being convex near the optical axis and an image-side surface being concave near the optical axis, at least one of the object-side surface and the image-side surface of the third lens element being aspheric; a fourth lens element with a positive refractive power having an object-side surface being convex near the optical axis and an image-side surface being concave near the optical axis, at least one of the object-side surface and the image-side surface of the fourth lens element being aspheric; a fifth lens element with a positive refractive power having an object-side surface being convex near the optical axis and an image-side surface being convex near the optical axis, at least one of the object-side surface and the image-side surface of the fifth lens element being aspheric and provided with at least one inflection point; and a sixth lens element with a negative refractive power having an object-side surface being convex near the optical axis and an image-side surface being concave near the optical axis, at least one of the object-side surface and the image-side surface of the sixth lens element being aspheric and provided with at least one inflection point.

Wherein a central thickness of the first lens element along the optical axis is CT1, a central thickness of the third lens element along the optical axis is CT3, a central thickness of the fourth lens element along the optical axis is CT4, a central thickness of the fifth lens element along the optical axis is CT5, a central thickness of the sixth lens element along the optical axis is CT6, and they satisfy the relations: 0.82<(CT4+CT5)/(CT1+CT3+CT6)<1.96; 2.07<(CT1+CT6)/CT3<5.52.

Therefore, when (CT4+CT5)/(CT1+CT3+CT6) satisfies the above relation, it can balance the thickness distribution of the lens elements of the six-piece optical lens system with a wide field of view, so as to avoid the improper use of space due to the large difference of lens thickness. When (CT1+CT6)/CT3 satisfies the above relation, it can balance the thickness distribution of the lens elements of the six-piece optical lens system with a wide field of view, so as to avoid the improper use of space due to the large difference of lens thickness, and also can enhance the system control ability of the third lens element.

Preferably, a focal length of the six-piece optical lens system with a wide field of view is f, a focal length of the fourth lens element and the fifth lens element combined is f45, and they satisfy the relation: 0.45<f/f45<1.34, which can make the fourth lens element matched with the fifth lens element to correct off-axis aberration.

Preferably, a focal length of the second lens element, the third lens element, the fourth lens element, the fifth lens element and the sixth lens element combined is f23456, the focal length of the six-piece optical lens system with a wide field of view is f, and they satisfy the relation: 0.56<f/f23456<1.51, so that a wide field of view can be provided and the resolution can be improved evidently.

Preferably, a focal length of the third lens element is f3, the focal length of the fourth lens element and the fifth lens element combined is f45, and they satisfy the relation: −3.75<f3/f45<−1.62, so that the distribution of the refractive powers of the fourth lens element and the fifth lens element will be appropriate, so as to reduce the sensitivity of the imaging optical lens system effectively.

Preferably, the focal length of the fourth lens element and the fifth lens element combined is f45, a focal length of the sixth lens element is f6, and they satisfy the relation: −6.04<f6/f45<−0.95, so that a wide field of view, high pixel and low height can be provided and the resolution can be improved evidently.

Preferably, the central thickness of the fourth lens element along the optical axis is CT4, the central thickness of the fifth lens element along the optical axis is CT5, the central thickness of the third lens element along the optical axis is CT3, and they satisfy the relation: 3.78<(CT4+CT5)/CT3<8.38, which can balance the thickness distribution of the lens elements of the six-piece optical lens system with a wide field of view, so as to avoid the improper use of space due to the large difference of lens thickness.

Preferably, a central thickness of the second lens element along the optical axis is CT2, the central thickness of the third lens element along the optical axis is CT3, and they satisfy the relation: 2.41<CT2/CT3<5.78, which can adjust the thickness ratio of the second lens element and the third lens element, so as to balance the spatial distribution of the six-piece optical lens system with a wide field of view, thus improving the yield rate and quality.

Preferably, the central thickness of the sixth lens element along the optical axis is CT6, the central thickness of the third lens element along the optical axis is CT3, and they satisfy the relation: 1.07<CT6/CT3<2.86, which can adjust the thickness ratio of the third lens element and the sixth lens element, so as to balance the spatial distribution of the six-piece optical lens system with a wide field of view, thus improving the yield rate and quality, and also can enhance the system control ability of the third lens element.

Preferably, the central thickness of the fourth lens element along the optical axis is CT4, the central thickness of the fifth lens element along the optical axis is CT5, the central thickness of the first lens element along the optical axis is CT1, and they satisfy the relation: 1.41<(CT4+CT5)/CT1<7.4, which can balance the thickness distribution of the lens elements of the six-piece optical lens system with a wide field of view, so as to avoid the improper use of space due to the large difference of lens thickness.

Preferably, the focal length of the second lens element, the third lens element, the fourth lens element, the fifth lens element and the sixth lens element combined is f23456, half of an image height that can be captured by the six-piece optical lens system with a wide field of view on an image plane is IMH, and they satisfy the relation: 0.99<IMH/f23456<1.98, so that the reducing of the volume of the system and the increasing of the image plane area can be balanced.

Preferably, the focal length of the six-piece optical lens system with a wide field of view is f, half of the image height that can be captured by the six-piece optical lens system with a wide field of view on the image plane is IMH, and they satisfy the relation: 0.9<IMH/f<2.69, so that the reducing of the volume of the system and the increasing of the image plane area can be balanced.

Preferably, a distance from the image-side surface of the sixth lens element to the image plane along the optical axis is BFL, the focal length of the six-piece optical lens system with a wide field of view is f, and they satisfy the relation: 0.79<f/BFL<2.17, so that the reducing of the volume of the system and the increasing of the image plane area can be balanced.

Preferably, half of the image height that can be captured by the six-piece optical lens system with a wide field of view on the image plane is IMH, a distance from the stop to the image plane along the optical axis is CTSI, and they satisfy the relation: 0.73<CTSI/(IMH*2)<1.2, so that the reducing of the volume of the system and the increasing of the image plane area can be balanced.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A shows a six-piece optical lens system with a wide field of view in accordance with a first embodiment of the present invention;

FIG. 1B shows the image plane curve and the distortion curve of the first embodiment of the present invention;

FIG. 2A shows a six-piece optical lens system with a wide field of view in accordance with a second embodiment of the present invention;

FIG. 2B shows the image plane curve and the distortion curve of the second embodiment of the present invention;

FIG. 3A shows a six-piece optical lens system with a wide field of view in accordance with a third embodiment of the present invention;

FIG. 3B shows the image plane curve and the distortion curve of the third embodiment of the present invention;

FIG. 4A shows a six-piece optical lens system with a wide field of view in accordance with a fourth embodiment of the present invention;

FIG. 4B shows the image plane curve and the distortion curve of the fourth embodiment of the present invention;

FIG. 5A shows a six-piece optical lens system with a wide field of view in accordance with a fifth embodiment of the present invention;

FIG. 5B shows the image plane curve and the distortion curve of the fifth embodiment of the present invention;

FIG. 6A shows a six-piece optical lens system with a wide field of view in accordance with a sixth embodiment of the present invention;

FIG. 6B shows the image plane curve and the distortion curve of the sixth embodiment of the present invention;

FIG. 7A shows a six-piece optical lens system with a wide field of view in accordance with a seventh embodiment of the present invention;

FIG. 7B shows the image plane curve and the distortion curve of the seventh embodiment of the present invention;

FIG. 8A shows a six-piece optical lens system with a wide field of view in accordance with an eighth embodiment of the present invention;

FIG. 8B shows the image plane curve and the distortion curve of the eighth embodiment of the present invention;

FIG. 9A shows a six-piece optical lens system with a wide field of view in accordance with a ninth embodiment of the present invention;

FIG. 9B shows the image plane curve and the distortion curve of the ninth embodiment of the present invention;

FIG. 10A shows a six-piece optical lens system with a wide field of view in accordance with a tenth embodiment of the present invention;

FIG. 10B shows the image plane curve and the distortion curve of the tenth embodiment of the present invention;

FIG. 11A shows a six-piece optical lens system with a wide field of view in accordance with an eleventh embodiment of the present invention; and

FIG. 11B shows the image plane curve and the distortion curve of the eleventh embodiment of the present invention.

### DETAILED DESCRIPTION

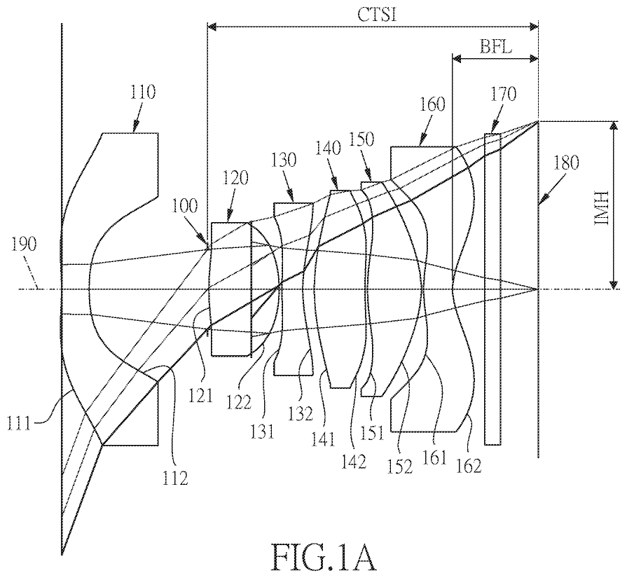

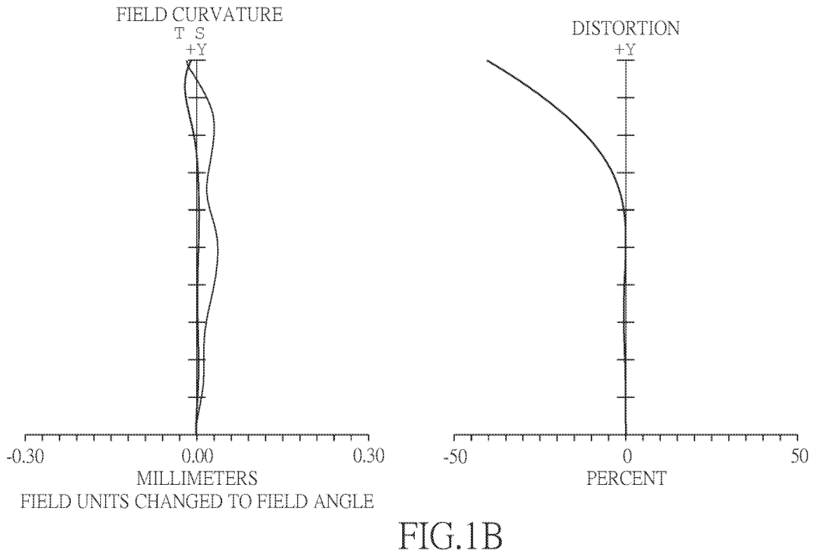

Referring to FIGS. 1A and 1B, FIG. 1A shows a six-piece optical lens system with a wide field of view in accordance with a first embodiment of the present invention, and FIG. 1B shows, in order from left to right, the image plane curve and the distortion curve of the first embodiment of the present invention. A six-piece optical lens system with a wide field of view in accordance with the first embodiment of the present invention comprises a stop 100 and a lens group. The lens group comprises, in order from an object side to an image side: a first lens element 110, a second lens element 120, a third lens element 130, a fourth lens element 140, a fifth lens element 150, a sixth lens element 160, an IR cut filter 170, and an image plane 180, wherein the six-piece optical lens system with a wide field of view has a total of six lens elements with refractive power. The stop 100 is disposed between the first lens element 110 and the second lens element 120.

The first lens element 110 with a negative refractive power has an object-side surface 111 being concave near an optical axis 190 and an image-side surface 112 being concave near the optical axis 190, the object-side surface 111 and the image-side surface 112 are aspheric, and the first lens element 110 is made of plastic material.

The second lens element 120 with a positive refractive power has an object-side surface 121 being convex near the optical axis 190 and an image-side surface 122 being convex near the optical axis 190, the object-side surface 121 and the image-side surface 122 are aspheric, and the second lens element 120 is made of plastic material.

The third lens element 130 with a negative refractive power has an object-side surface 131 being convex near the optical axis 190 and an image-side surface 132 being concave near the optical axis 190, the object-side surface 131 and the image-side surface 132 are aspheric, and the third lens element 130 is made of plastic material.

The fourth lens element 140 with a positive refractive power has an object-side surface 141 being convex near the optical axis 190 and an image-side surface 142 being concave near the optical axis 190, the object-side surface 141 and the image-side surface 142 are aspheric, and the fourth lens element 140 is made of plastic material.

The fifth lens element 150 with a positive refractive power has an object-side surface 151 being convex near the optical axis 190 and an image-side surface 152 being convex near the optical axis 190, the object-side surface 151 and the image-side surface 152 are aspheric, the fifth lens element 150 is made of plastic material, and the object-side surface 151 is provided with at least one inflection point.

The sixth lens element 160 with a negative refractive power has an object-side surface 161 being convex near the optical axis 190 and an image-side surface 162 being concave near the optical axis 190, the object-side surface 161 and the image-side surface 162 are aspheric and are provided with at least one inflection point, the sixth lens element 160 is made of plastic material.

The IR cut filter 170 made of glass is located between the sixth lens element 160 and the image plane 180 and has no influence on the focal length of the six-piece optical lens system with a wide field of view.

The equation for the aspheric surface profiles of the respective lens elements of the first embodiment is expressed as follows:

$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + {Fh}^{14} + ……… .$$

wherein:

z represents the value of a reference position with respect to a vertex of the surface of a lens and a position with a height h along the optical axis 190;

c represents a paraxial curvature equal to 1/R (R: a paraxial radius of curvature);

h represents a vertical distance from the point on the curve of the aspheric surface to the optical axis 190;

k represents the conic constant;

A, B, C, D, E, F, . . . : represent the high-order aspheric coefficients.

In the first embodiment of the present six-piece optical lens system with a wide field of view, a focal length of the six-piece optical lens system with a wide field of view is f, a f-number of the six-piece optical lens system with a wide field of view is Fno, the six-piece optical lens system with a wide field of view has a maximum view angle (field of view) FOV, and they satisfy the relations: f=1.38 mm; Fno=2.07; and FOV=140.09 degrees.

In the first embodiment of the present six-piece optical lens system with a wide field of view, a central thickness of the first lens element 110 along the optical axis 190 is CT1, a central thickness of the third lens element 130 along the optical axis 190 is CT3, a central thickness of the fourth lens element 140 along the optical axis 190 is CT4, a central thickness of the fifth lens element 150 along the optical axis 190 is CT5, a central thickness of the sixth lens element 160 along the optical axis 190 is CT6, and they satisfy the relations: (CT4+CT5)/(CT1+CT3+CT6)=1.353; (CT1+CT6)/CT3=2.727.

In the first embodiment of the present six-piece optical lens system with a wide field of view, the focal length of the six-piece optical lens system with a wide field of view is f, a focal length of the fourth lens element 140 and the fifth lens element 150 combined is f45, and they satisfy the relation: f/f45=0.805.

In the first embodiment of the present six-piece optical lens system with a wide field of view, a focal length of the second lens element 120, the third lens element 130, the fourth lens element 140, the fifth lens element 150 and the sixth lens element 160 combined is f23456, the focal length of the six-piece optical lens system with a wide field of view is f, and they satisfy the relation: f/f23456=0.841.

In the first embodiment of the present six-piece optical lens system with a wide field of view, a focal length of the third lens element 130 is f3, the focal length of the fourth lens element 140 and the fifth lens element 150 combined is f45, and they satisfy the relation: f3/f45=−2.510.

In the first embodiment of the present six-piece optical lens system with a wide field of view, the focal length of the fourth lens element 140 and the fifth lens element 150 combined is f45, a focal length of the sixth lens element 160 is f6, and they satisfy the relation: f6/f45=−1.590.

In the first embodiment of the present six-piece optical lens system with a wide field of view, the central thickness of the fourth lens element 140 along the optical axis 190 is CT4, the central thickness of the fifth lens element 150 along the optical axis 190 is CTS, the central thickness of the third lens element 130 along the optical axis 190 is CT3, and they satisfy the relation: (CT4+CT5)/CT3=5.042.

In the first embodiment of the present six-piece optical lens system with a wide field of view, a central thickness of the second lens element 120 along the optical axis 190 is CT2, the central thickness of the third lens element 130 along the optical axis 190 is CT3, and they satisfy the relation: CT2/CT3=3.397.

In the first embodiment of the present six-piece optical lens system with a wide field of view, the central thickness of the sixth lens element 160 along the optical axis 190 is CT6, the central thickness of the third lens element 130 along the optical axis 190 is CT3, and they satisfy the relation: CT6/CT3=1.401.

In the first embodiment of the present six-piece optical lens system with a wide field of view, the central thickness of the fourth lens element 140 along the optical axis 190 is CT4, the central thickness of the fifth lens element 150 along the optical axis 190 is CT5, and they satisfy the relation: (CT4+CT5)/CT1=3.804.

In the first embodiment of the present six-piece optical lens system with a wide field of view, the focal length of the second lens element 120, the third lens element 130, the fourth lens element 140, the fifth lens element 150 and the sixth lens element 160 combined is f23456, half of an image height that can be captured by the six-piece optical lens system with a wide field of view on the image plane 180 is IMH, and they satisfy the relation: IMH/f23456=1.381.

In the first embodiment of the present six-piece optical lens system with a wide field of view, the focal length of the six-piece optical lens system with a wide field of view is f, half of the image height that can be captured by the six-piece optical lens system with a wide field of view on the image plane 180 is IMH, and they satisfy the relation: IMH/f=1.642.

In the first embodiment of the present six-piece optical lens system with a wide field of view, a distance from the image-side surface 162 of the sixth lens element 160 to the image plane 180 along the optical axis 190 is BFL, the focal length of the six-piece optical lens system with a wide field of view is f, and they satisfy the relation: f/BFL=1.221.

In the first embodiment of the present six-piece optical lens system with a wide field of view, half of the image height that can be captured by the six-piece optical lens system with a wide field of view on the image plane 180 is IMH, a distance from the stop 100 to the image plane 180 along the optical axis 190 is CTSI, and they satisfy the relation: CTSI/(IMH*2)=0.961.

The detailed optical data of the first embodiment is shown in table 1, and the aspheric surface data is shown in table 2.

TABLE 1
Embodiment 1
f(focal length) = 1.38 mm, Fno = 2.07, FOV = 140.09 deg.

| surface | | Curvature Radius | | Thickness | Material | Index | Abbe # | Focal length |
|---|---|---|---|---|---|---|---|---|
| 0 | object | infinity | | 400.000 | | | | |
| 1 | test surface | infinity | | 0.000 | | | | |
| 2 | Lens 1 | −4.455 | (ASP) | 0.362 | plastic | 1.55 | 56.0 | −2.81 |
| 3 | | 2.414 | (ASP) | 1.562 | | | | |
| 4 | stop | infinity | | 0.018 | | | | |
| 5 | Lens 2 | 3.208 | (ASP) | 0.928 | plastic | 1.54 | 55.6 | 2.21 |
| 6 | | −1.695 | (ASP) | −0.369 | | | | |
| 7 | shading surface | infinity | | 0.405 | | | | |
| 8 | Lens 3 | 6.636 | (ASP) | 0.273 | plastic | 1.68 | 19.2 | −4.31 |
| 9 | | 1.994 | (ASP) | 0.153 | | | | |
| 10 | Lens 4 | 2.686 | (ASP) | 0.668 | plastic | 1.55 | 56.0 | 9.55 |
| 11 | | 5.049 | (ASP) | 0.033 | | | | |
| 12 | Lens 5 | 2.703 | (ASP) | 0.709 | plastic | 1.54 | 55.6 | 1.83 |
| 13 | | −1.404 | (ASP) | 0.030 | | | | |
| 14 | Lens 6 | 1.567 | (ASP) | 0.383 | plastic | 1.67 | 20.4 | −2.73 |
| 15 | | 0.760 | (ASP) | 0.422 | | | | |

| | | | | | | |
|---|---|---|---|---|---|---|
| 16 | IR-filter | infinity | 0.210 | glass | 1.52 | 64.2 |
| 17 | | infinity | 0.500 | | | |
| 18 | Image plane | infinity | 0.000 | | | |

TABLE 2
Aspheric Coefficients

| surface | 2 | 3 | 5 | 6 | 8 | 9 |
|---|---|---|---|---|---|---|
| K: | 1.8033E+00 | −1.8506E+01 | −4.1212E−01 | −8.1728E−01 | −5.1294E+01 | −6.8567E+00 |
| A: | 0.0000E+00 | 0.0000E+00 | 0.0000E+00 | 0.0000E+00 | 0.0000E+00 | 0.0000E+00 |
| B: | 2.5728E−01 | 4.4084E−01 | −1.2470E−02 | −2.7427E−01 | −3.1013E−01 | −1.3569E−01 |
| C: | −1.5367E−01 | −1.3342E−01 | −2.2175E+00 | 1.2324E+00 | 1.0516E+00 | 1.8853E−01 |
| D: | 6.7529E−02 | 2.6709E−01 | 2.4367E+01 | −7.2488E+00 | −4.5837E+00 | −2.6678E−01 |
| E: | −1.9822E−02 | −6.9601E−01 | −1.4686E+02 | 2.0455E+01 | 1.0934E+01 | 2.5485E−01 |
| F: | 3.5707E−03 | 8.9619E−01 | 4.7894E+02 | −3.0659E+01 | −1.4120E+01 | −1.3150E−01 |
| G: | −3.5704E−04 | −5.2074E−01 | −8.2023E+02 | 2.2976E+01 | 9.3269E+00 | 2.8270E−02 |
| H: | 1.5140E−05 | 1.0811E−01 | 5.7891E+02 | −6.8683E+00 | −2.4770E+00 | −2.1383E−03 |
| surface | 10 | 11 | 12 | 13 | 14 | 15 |
| K: | −1.7099E+01 | 6.4947E+00 | −9.0586E+00 | −5.2435E−01 | −1.4750E+01 | −4.4180E+00 |
| A: | 0.0000E+00 | 0.0000E+00 | 0.0000E+00 | 0.0000E+00 | 0.0000E+00 | 0.0000E+00 |
| B: | 5.6351E−02 | −8.9800E−02 | 2.0941E−02 | 1.1868E−01 | −2.4676E−01 | −1.4722E−01 |
| C: | −2.4594E−01 | −1.5097E−01 | −1.7106E−01 | 1.3721E−01 | 5.5292E−02 | 7.0678E−02 |
| D: | 6.2960E−01 | −4.6884E−01 | −2.7705E−01 | −3.0645E−01 | −7.4005E−03 | −2.7183E−02 |
| E: | −8.2702E−01 | 1.5001E+00 | 8.1279E−01 | 2.1310E−01 | −1.7512E−03 | 5.6193E−03 |
| F: | 5.5903E−01 | −1.5046E+00 | −7.1026E−01 | −4.8598E−02 | −1.0156E−02 | −3.6748E−04 |
| G: | −1.8485E−01 | 6.6025E−01 | 2.7388E−01 | −6.9098E−03 | 9.9466E−03 | −3.5930E−05 |
| H: | 2.3527E−02 | −1.0813E−01 | −4.0508E−02 | 3.2529E−03 | −2.1848E−03 | 3.2433E−06 |

The units of the radius of curvature, the thickness and the focal length in table 1 are expressed in mm, the surface numbers 0-18 represent the surfaces sequentially arranged from the object-side to the image-side along the optical axis, and the test surface (i.e. surface 1) and the shading surface (i.e. surface 7) for allowing part of the light to pass through and part of the light shield. In table 2, k represents the conic coefficient of the equation of the aspheric surface profiles, and A, B, C, D, E, F . . . : represent the high-order aspheric coefficients. The tables presented below for each embodiment are the corresponding schematic parameter, image plane curves and distortion curves, and the definitions of the tables are the same as Table 1 and Table 2 of the first embodiment. Therefore, an explanation in this regard will not be provided again.

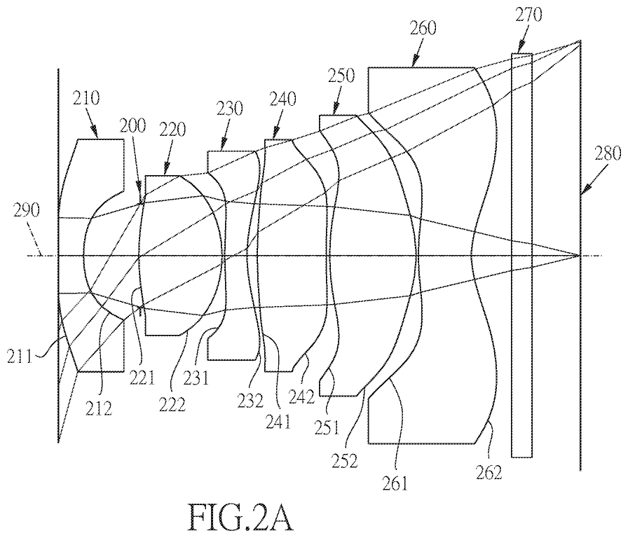

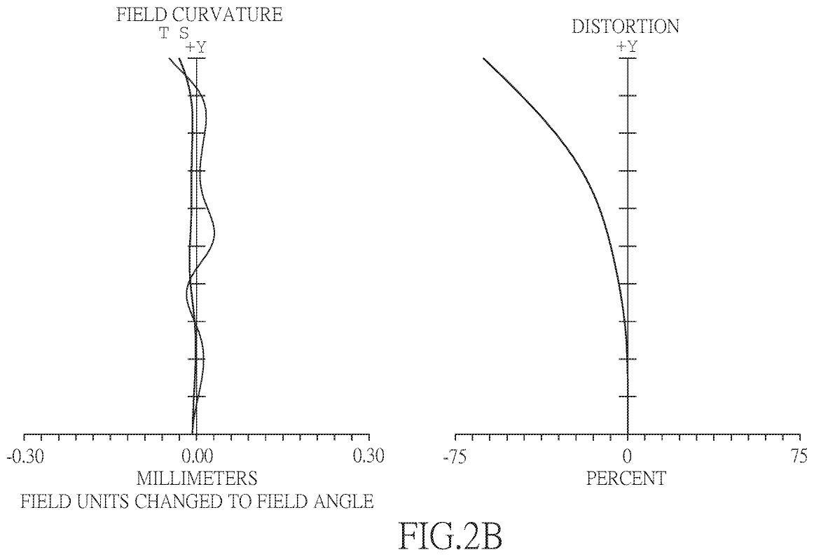

Referring to FIGS. 2A and 2B, FIG. 2A shows a six-piece optical lens system with a wide field of view in accordance with a second embodiment of the present invention, and FIG. 2B shows, in order from left to right, the image plane curve and the distortion curve of the second embodiment of the present invention. A six-piece optical lens system with a wide field of view in accordance with the second embodiment of the present invention comprises a stop 200 and a lens group. The lens group comprises, in order from an object side to an image side: a first lens element 210, a second lens element 220, a third lens element 230, a fourth lens element 240, a fifth lens element 250, a sixth lens element 260, an IR cut filter 270, and an image plane 280, wherein the six-piece optical lens system with a wide field of view has a total of six lens elements with refractive power. The stop 200 is disposed between the first lens element 210 and the second lens element 220.

The first lens element 210 with a negative refractive power has an object-side surface 211 being concave near an optical axis 290 and an image-side surface 212 being concave near the optical axis 290, the object-side surface 211 and the image-side surface 212 are aspheric, and the first lens element 210 is made of plastic material.

The second lens element 220 with a positive refractive power has an object-side surface 221 being convex near the optical axis 290 and an image-side surface 222 being convex near the optical axis 290, the object-side surface 221 and the image-side surface 222 are aspheric, and the second lens element 220 is made of plastic material.

The third lens element 230 with a negative refractive power has an object-side surface 231 being convex near the optical axis 290 and an image-side surface 232 being concave near the optical axis 290, the object-side surface 231 and the image-side surface 232 are aspheric, and the third lens element 230 is made of plastic material.

The fourth lens element 240 with a positive refractive power has an object-side surface 241 being convex near the optical axis 290 and an image-side surface 242 being concave near the optical axis 290, the object-side surface 241 and the image-side surface 242 are aspheric, and the fourth lens element 240 is made of plastic material.

The fifth lens element 250 with a positive refractive power has an object-side surface 251 being convex near the optical axis 290 and an image-side surface 252 being convex near the optical axis 290, the object-side surface 251 and the image-side surface 252 are aspheric, the fifth lens element 250 is made of plastic material, and the object-side surface 251 is provided with at least one inflection point.

The sixth lens element 260 with a negative refractive power has an object-side surface 261 being convex near the optical axis 290 and an image-side surface 262 being concave near the optical axis 290, the object-side surface 261 and the image-side surface 262 are aspheric and are provided with at least one inflection point, the sixth lens element 260 is made of plastic material.

The IR cut filter 270 made of glass is located between the sixth lens element 260 and the image plane 280 and has no influence on the focal length of the six-piece optical lens system with a wide field of view. The detailed optical data of the second embodiment is shown in table 3, and the aspheric surface data is shown in table 4.

TABLE 3
Embodiment 2
f(focal length) = 1.64 mm, Fno = 2.05, FOV = 149.97 deg.

| surface | | Curvature Radius | | Thickness | Material | Index | Abbe # | Focal length |
|---|---|---|---|---|---|---|---|---|
| 0 | object | infinity | | 1.0E+10 | | | | |
| 1 | test surface | infinity | | 0.000 | | | | |
| 2 | Lens 1 | −8.080 | (ASP) | 0.260 | plastic | 1.55 | 56.0 | −1.93 |
| 3 | | 1.223 | (ASP) | 0.586 | | | | |
| 4 | stop | infinity | | −0.013 | | | | |
| 5 | Lens 2 | 2.833 | (ASP) | 0.859 | plastic | 1.55 | 56.0 | 1.69 |
| 6 | | −1.226 | (ASP) | 0.027 | | | | |
| 7 | Lens 3 | 3.328 | (ASP) | 0.230 | plastic | 1.65 | 22.5 | −4.12 |
| 8 | | 1.440 | (ASP) | 0.106 | | | | |
| 9 | Lens 4 | 4.088 | (ASP) | 0.712 | plastic | 1.55 | 56.0 | 13.68 |
| 10 | | 8.467 | (ASP) | 0.037 | | | | |
| 11 | Lens 5 | 2.929 | (ASP) | 0.891 | plastic | 1.55 | 56.0 | 1.86 |
| 12 | | −1.383 | (ASP) | 0.025 | | | | |
| 13 | Lens 6 | 2.329 | (ASP) | 0.548 | plastic | 1.65 | 22.4 | −2.79 |
| 14 | | 0.923 | (ASP) | 0.416 | | | | |

| | | | | | | |
|---|---|---|---|---|---|---|
| 15 | IR-filter | infinity | 0.210 | glass | 1.52 | 64.2 |
| 16 | | infinity | 0.500 | | | |
| 17 | Image plane | infinity | 0.000 | | | |

TABLE 4
Aspheric Coefficients

| surface | 2 | 3 | 5 | 6 | 7 | 8 |
|---|---|---|---|---|---|---|
| K: | 2.0902E+01 | −2.3770E+01 | −5.7981E−01 | −1.4242E+00 | −4.1036E+01 | −3.6436E+00 |
| A: | 0.0000E+00 | 0.0000E+00 | 0.0000E+00 | 0.0000E+00 | 0.0000E+00 | 0.0000E+00 |
| B: | 5.4392E−01 | 1.9895E+00 | 5.3548E−02 | −1.7229E−01 | −3.2487E−01 | −3.6250E−01 |
| C: | −8.1139E−01 | −3.5820E+00 | −2.9415E−01 | −2.5246E−01 | 4.3864E−01 | 7.6612E−01 |
| D: | 9.2492E−01 | 7.7508E+00 | 1.7662E+00 | 5.4403E−01 | −1.9190E+00 | −1.2386E+00 |
| E: | −7.1055E−01 | −7.8825E+00 | −7.8665E+00 | −1.7794E+00 | 3.5255E+00 | 1.2506E+00 |
| F: | 3.0365E−01 | 8.4527E+00 | 1.3335E+01 | 3.0778E+00 | −4.5595E+00 | −7.5941E−01 |
| G: | −5.3904E−02 | −5.0481E+00 | −8.5098E+00 | −2.2341E+00 | 2.5233E+00 | 1.9171E−01 |
| H: | 0.0000E+00 | 0.0000E+00 | 0.0000E+00 | 0.0000E+00 | 0.0000E+00 | 0.0000E+00 |
| surface | 9 | 10 | 11 | 12 | 13 | 14 |
| K: | 9.4384E+00 | 3.6131E+00 | −5.1848E+01 | −6.4854E−01 | −1.9794E+01 | −3.9990E+00 |
| A: | 0.0000E+00 | 0.0000E+00 | 0.0000E+00 | 0.0000E+00 | 0.0000E+00 | 0.0000E+00 |
| B: | −1.7365E−01 | 1.5923E−01 | 4.9008E−01 | 1.8041E−01 | −1.5661E−01 | −1.8916E−01 |
| C: | 3.9728E−02 | −1.2953E+00 | −1.3254E+00 | 1.4411E−01 | −9.0992E−02 | 1.2288E−01 |
| D: | 5.1199E−01 | 1.6203E+00 | 1.5910E+00 | −3.9661E−01 | 1.0686E−01 | −5.9664E−02 |
| E: | −8.3925E−01 | −9.3373E−01 | −1.1494E+00 | 3.2798E−01 | −8.6554E−02 | 1.9658E−02 |
| F: | 4.9844E−01 | 6.8595E−02 | 4.4567E−01 | −1.5536E−01 | 4.4730E−02 | −4.3283E−03 |
| G: | −1.0976E−01 | 1.9009E−01 | −7.3124E−02 | 4.2170E−02 | −1.0051E−02 | 5.6746E−04 |
| H: | 0.0000E+00 | −6.1317E−02 | 2.0377E−03 | −4.8195E−03 | 6.9953E−04 | −3.2556E−05 |

In the second embodiment, the equation of the aspheric surface profiles of the aforementioned lens elements is the same as the equation of the first embodiment. Also, the definitions of these parameters shown in the following table are the same as those stated in the first embodiment with corresponding values for the second embodiment, so an explanation in this regard will not be provided again.

Moreover, these parameters can be calculated from Table 3 and Table 4 as the following values and satisfy the following conditions:

Embodiment 2

| | | | |
|---|---|---|---|
| f[mm] | 1.64 | (CT4 + CT5)/CT3 | 6.982 |
| Fno | 2.05 | CT2/CT3 | 3.739 |
| FOV[deg.] | 149.97 | CT6/CT3 | 2.384 |
| (CT4 + CT5)/(CT1 + CT3 + CT6) | 1.546 | (CT4 + CT5)/CT1 | 6.168 |
| (CT1 + CT6)/CT3 | 3.516 | IMH/f23456 | 1.646 |
| f/f45 | 0.917 | IMH/f | 1.388 |
| f/f23456 | 1.186 | f/BFL | 1.453 |
| f3/f45 | −2.309 | CTSI/(IMH*2) | 1.001 |
| f6/f45 | −1.563 | | |

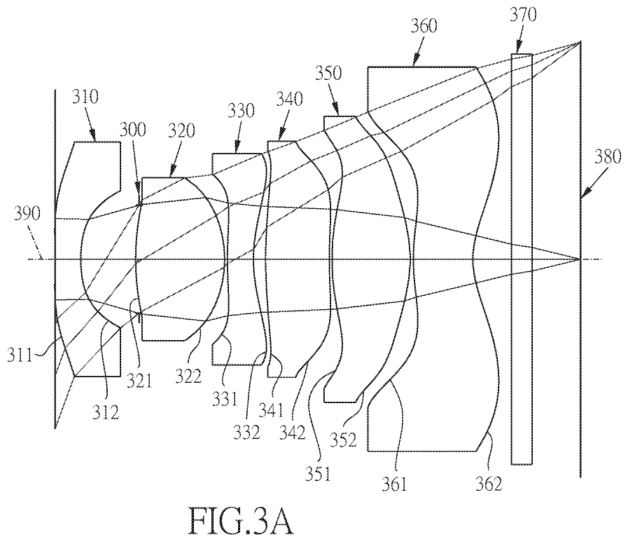

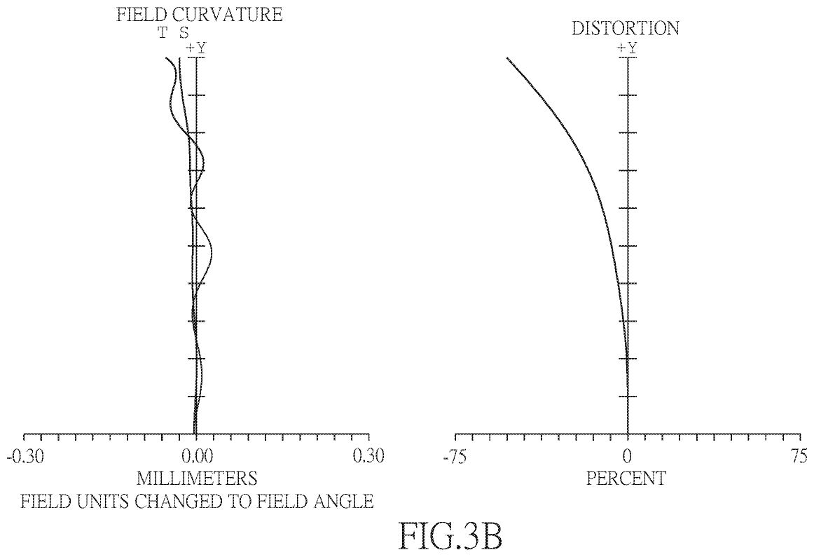

Referring to FIGS. 3A and 3B, FIG. 3A shows a six-piece optical lens system with a wide field of view in accordance with a third embodiment of the present invention, and FIG. 3B shows, in order from left to right, the image plane curve and the distortion curve of the third embodiment of the present invention. A six-piece optical lens system with a wide field of view in accordance with the third embodiment of the present invention comprises a stop 300 and a lens group. The lens group comprises, in order from an object side to an image side: a first lens element 310, a second lens element 320, a third lens element 330, a fourth lens element 340, a fifth lens element 350, a sixth lens element 360, an IR cut filter 370, and an image plane 380, wherein the six-piece optical lens system with a wide field of view has a total of six lens elements with refractive power. The stop 300 is disposed between the first lens element 310 and the second lens element 320.

The first lens element 310 with a negative refractive power has an object-side surface 311 being concave near an optical axis 390 and an image-side surface 312 being concave near the optical axis 390, the object-side surface 311 and the image-side surface 312 are aspheric, and the first lens element 310 is made of plastic material.

The second lens element 320 with a positive refractive power has an object-side surface 321 being convex near the optical axis 390 and an image-side surface 322 being convex near the optical axis 390, the object-side surface 321 and the image-side surface 322 are aspheric, and the second lens element 320 is made of plastic material.

The third lens element 330 with a negative refractive power has an object-side surface 331 being convex near the optical axis 390 and an image-side surface 332 being concave near the optical axis 390, the object-side surface 331 and the image-side surface 332 are aspheric, and the third lens element 330 is made of plastic material.

The fourth lens element 340 with a positive refractive power has an object-side surface 341 being convex near the optical axis 390 and an image-side surface 342 being concave near the optical axis 390, the object-side surface 341 and the image-side surface 342 are aspheric, and the fourth lens element 340 is made of plastic material.

The fifth lens element 350 with a positive refractive power has an object-side surface 351 being convex near the optical axis 390 and an image-side surface 352 being convex near the optical axis 390, the object-side surface 351 and the image-side surface 352 are aspheric, the fifth lens element 350 is made of plastic material, and the object-side surface 351 is provided with at least one inflection point.

The sixth lens element 360 with a negative refractive power has an object-side surface 361 being convex near the optical axis 390 and an image-side surface 362 being concave near the optical axis 390, the object-side surface 361 and the image-side surface 362 are aspheric and are provided with more than one inflection point, the sixth lens element 360 is made of plastic material.

The IR cut filter 370 made of glass is located between the sixth lens element 360 and the image plane 380 and has no influence on the focal length of the six-piece optical lens system with a wide field of view.

The detailed optical data of the third embodiment is shown in table 5, and the aspheric surface data is shown in table 6.

TABLE 5
Embodiment 3
f(focal length) = 1.74 mm, Fno = 2.05, FOV = 140.02 deg.

| surface | | Curvature Radius | | Thickness | Material | Index | Abbe # | Focal length |
|---|---|---|---|---|---|---|---|---|
| 0 | object | infinity | | 1.0E+06 | | | | |
| 1 | test surface | infinity | | 0.000 | | | | |
| 2 | Lens 1 | −7.542 | (ASP) | 0.265 | plastic | 1.55 | 56.0 | −2.18 |
| 3 | | 1.430 | (ASP) | 0.596 | | | | |
| 4 | stop | infinity | | −0.035 | | | | |
| 5 | Lens 2 | 2.741 | (ASP) | 0.914 | plastic | 1.55 | 56.0 | 1.73 |
| 6 | | −1.268 | (ASP) | 0.027 | | | | |
| 7 | Lens 3 | 3.450 | (ASP) | 0.267 | plastic | 1.65 | 22.5 | −3.91 |
| 8 | | 1.416 | (ASP) | 0.126 | | | | |
| 9 | Lens 4 | 4.422 | (ASP) | 0.654 | plastic | 1.55 | 56.0 | 20.05 |
| 10 | | 7.030 | (ASP) | 0.028 | | | | |
| 11 | Lens 5 | 3.039 | (ASP) | 0.802 | plastic | 1.55 | 56.0 | 1.91 |
| 12 | | −1.435 | (ASP) | 0.031 | | | | |
| 13 | Lens 6 | 2.196 | (ASP) | 0.611 | plastic | 1.65 | 22.4 | −2.83 |
| 14 | | 0.890 | (ASP) | 0.397 | | | | |

| | | | | | | |
|---|---|---|---|---|---|---|
| 15 | IR-filter | infinity | 0.210 | glass | 1.52 | 64.2 |
| 16 | | infinity | 0.500 | | | |
| 17 | Image plane | infinity | 0.000 | | | |

TABLE 6
Aspheric Coefficients

| surface | 2 | 3 | 5 | 6 | 7 | 8 |
|---|---|---|---|---|---|---|
| K: | 1.9865E+01 | −2.9212E+01 | −2.7476E−01 | −1.5898E+00 | −3.6498E+01 | −3.9947E+00 |
| A: | 0.0000E+00 | 0.0000E+00 | 0.0000E+00 | 0.0000E+00 | 0.0000E+00 | 0.0000E+00 |
| B: | 5.2539E−01 | 1.6990E+00 | 4.5849E−02 | −2.4791E−01 | −4.8445E−01 | −4.2356E−01 |
| C: | −7.2810E−01 | −2.8324E+00 | −9.2923E−02 | 9.6471E−01 | 1.8369E+00 | 1.1919E+00 |
| D: | 7.9866E−01 | 5.9710E+00 | 5.2390E−01 | −4.2483E+00 | −6.2384E+00 | −2.2916E+00 |
| E: | −5.9718E−01 | −6.7877E+00 | −4.0608E+00 | 7.8634E+00 | 1.0874E+01 | 2.5164E+00 |
| F: | 2.4440E−01 | 8.4394E+00 | 8.2425E+00 | −7.1030E+00 | −1.0839E+01 | −1.5007E+00 |
| G: | −4.0865E−02 | −8.4292E+00 | −6.1159E+00 | 2.3598E+00 | 4.5890E+00 | 3.6094E−01 |
| H: | 0.0000E+00 | 0.0000E+00 | 0.0000E+00 | 0.0000E+00 | 0.0000E+00 | 0.0000E+00 |
| surface | 9 | 10 | 11 | 12 | 13 | 14 |
| K: | 1.0133E+01 | 1.0844E+01 | −4.1430E+01 | −6.4646E−01 | −1.7973E+01 | −4.2444E+00 |
| A: | 0.0000E+00 | 0.0000E+00 | 0.0000E+00 | 0.0000E+00 | 0.0000E+00 | 0.0000E+00 |
| B: | −1.6927E−01 | 1.1787E−01 | 4.8203E−01 | 2.7239E−01 | −1.1087E−01 | −1.7704E−01 |
| C: | 2.8284E−01 | −1.1706E+00 | −1.4175E+00 | −1.7978E−01 | −2.0072E−01 | 1.2303E−01 |
| D: | −4.2967E−01 | 1.7860E+00 | 2.0706E+00 | 7.4975E−02 | 2.5089E−01 | −6.9220E−02 |
| E: | 4.5999E−01 | −1.5760E+00 | −1.8527E+00 | −1.9799E−03 | −1.9830E−01 | 2.5949E−02 |
| F: | −2.9811E−01 | 7.1961E−01 | 9.2162E−01 | −4.5297E−02 | 9.6686E−02 | −6.0651E−03 |
| G: | 7.0748E−02 | −1.0650E−01 | −2.2898E−01 | 2.7932E−02 | −2.3155E−02 | 7.9242E−04 |
| H: | 0.0000E+00 | −8.8696E−03 | 2.1983E−02 | −4.7195E−03 | 2.0779E−03 | −4.3751E−05 |

In the third embodiment, the equation of the aspheric surface profiles of the aforementioned lens elements is the same as the equation of the first embodiment. Also, the definitions of these parameters shown in the following table are the same as those stated in the first embodiment with corresponding values for the third embodiment, so an explanation in this regard will not be provided again.

Moreover, these parameters can be calculated from Table 5 and Table 6 as the following values and satisfy the following conditions:

Embodiment 3

| | | | |
|---|---|---|---|
| f[mm] | 1.74 | (CT4 + CT5)/CT3 | 5.459 |
| Fno | 2.05 | CT2/CT3 | 3.427 |
| FOV[deg.] | 140.02 | CT6/CT3 | 2.289 |
| (CT4 + CT5)/(CT1 + CT3 + CT6) | 1.275 | (CT4 + CT5)/CT1 | 5.491 |
| (CT1 + CT6)/CT3 | 3.283 | IMH/f23456 | 1.615 |
| f/f45 | 0.934 | IMH/f | 1.305 |
| f/f23456 | 1.238 | f/BFL | 1.572 |
| f3/f45 | −2.100 | CTSI/(IMH*2) | 0.998 |
| f6/f45 | −1.520 | | |

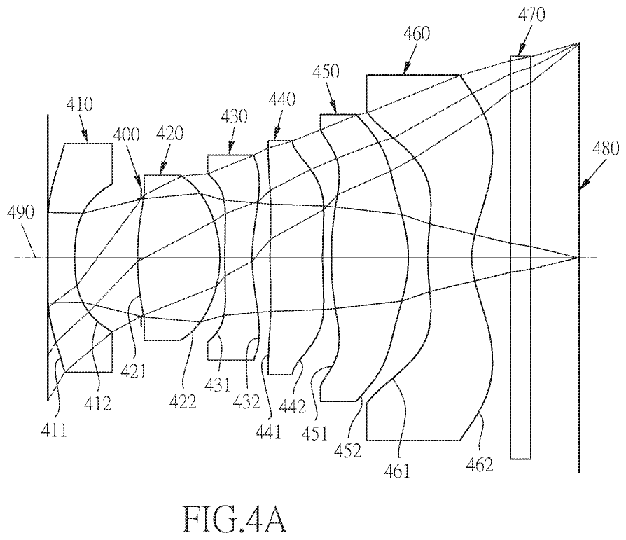

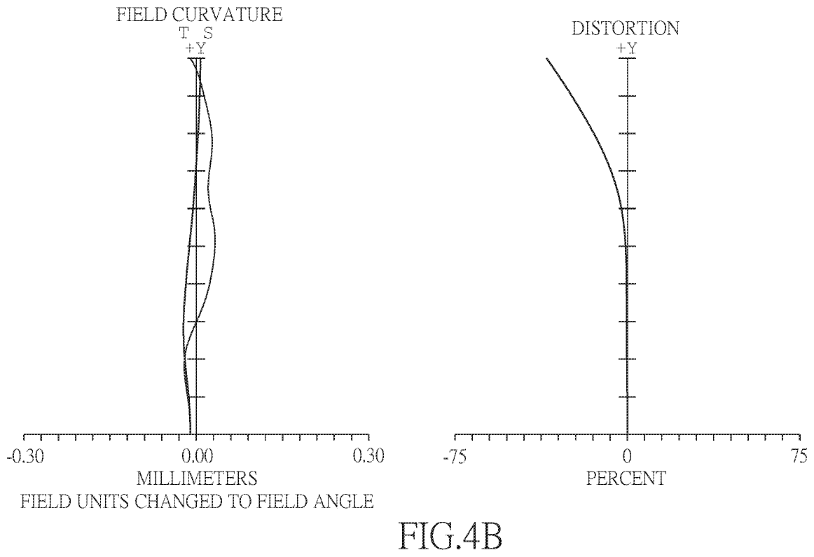

Referring to FIGS. 4A and 4B, FIG. 4A shows a six-piece optical lens system with a wide field of view in accordance with a fourth embodiment of the present invention, and FIG. 4B shows, in order from left to right, the image plane curve and the distortion curve of the fourth embodiment of the present invention. A six-piece optical lens system with a wide field of view in accordance with the fourth embodiment of the present invention comprises a stop 400 and a lens group. The lens group comprises, in order from an object side to an image side: a first lens element 410, a second lens element 420, a third lens element 430, a fourth lens element 440, a fifth lens element 450, a sixth lens element 460, an IR cut filter 470, and an image plane 480, wherein the six-piece optical lens system with a wide field of view has a total of six lens elements with refractive power. The stop 400 is disposed between the first lens element 410 and the second lens element 420.

The first lens element 410 with a negative refractive power has an object-side surface 411 being concave near an optical axis 490 and an image-side surface 412 being concave near the optical axis 490, the object-side surface 411 and the image-side surface 412 are aspheric, and the first lens element 410 is made of plastic material.

The second lens element 420 with a positive refractive power has an object-side surface 421 being convex near the optical axis 490 and an image-side surface 422 being convex near the optical axis 490, the object-side surface 421 and the image-side surface 422 are aspheric, and the second lens element 420 is made of plastic material.

The third lens element 430 with a negative refractive power has an object-side surface 431 being convex near the optical axis 490 and an image-side surface 432 being concave near the optical axis 490, the object-side surface 431 and the image-side surface 432 are aspheric, and the third lens element 430 is made of plastic material.

The fourth lens element 440 with a positive refractive power has an object-side surface 441 being convex near the optical axis 490 and an image-side surface 442 being concave near the optical axis 490, the object-side surface 441 and the image-side surface 442 are aspheric, and the fourth lens element 440 is made of plastic material.

The fifth lens element 450 with a positive refractive power has an object-side surface 451 being convex near the optical axis 490 and an image-side surface 452 being convex near the optical axis 490, the object-side surface 451 and the image-side surface 452 are aspheric, the fifth lens element 450 is made of plastic material, and the object-side surface 451 is provided with at least one inflection point.

The sixth lens element 460 with a negative refractive power has an object-side surface 461 being convex near the optical axis 490 and an image-side surface 462 being concave near the optical axis 490, the object-side surface 461 and the image-side surface 462 are aspheric and are provided with more than one inflection point, the sixth lens element 460 is made of plastic material.

The IR cut filter 470 made of glass is located between the sixth lens element 460 and the image plane 480 and has no influence on the focal length of the six-piece optical lens system with a wide field of view.

The detailed optical data of the fourth embodiment is shown in table 7, and the aspheric surface data is shown in table 8.

TABLE 7
Embodiment 4
f(focal length) = 2.01 mm, Fno = 2.11, FOV = 119.99 deg.

| surface | | Curvature Radius | | Thickness | Material | Index | Abbe # | Focal length |
|---|---|---|---|---|---|---|---|---|
| 0 | object | infinity | | 1.0E+06 | | | | |
| 1 | test surface | infinity | | 0.000 | | | | |
| 2 | Lens 1 | −5.770 | (ASP) | 0.277 | plastic | 1.55 | 56.0 | −2.99 |
| 3 | | 2.319 | (ASP) | 0.689 | | | | |
| 4 | stop | infinity | | −0.038 | | | | |
| 5 | Lens 2 | 3.113 | (ASP) | 0.853 | plastic | 1.55 | 56.0 | 1.77 |
| 6 | | −1.267 | (ASP) | 0.049 | | | | |
| 7 | Lens 3 | 5.244 | (ASP) | 0.283 | plastic | 1.65 | 22.5 | −4.26 |
| 8 | | 1.769 | (ASP) | 0.186 | | | | |
| 9 | Lens 4 | 5.662 | (ASP) | 0.544 | plastic | 1.55 | 56.0 | 57.16 |
| 10 | | 6.681 | (ASP) | 0.092 | | | | |
| 11 | Lens 5 | 6.644 | (ASP) | 0.796 | plastic | 1.55 | 56.0 | 2.09 |
| 12 | | −1.320 | (ASP) | 0.200 | | | | |
| 13 | Lens 6 | 2.138 | (ASP) | 0.456 | plastic | 1.65 | 22.5 | −2.70 |
| 14 | | 0.881 | (ASP) | 0.402 | | | | |

| | | | | | | |
|---|---|---|---|---|---|---|
| 15 | IR-filter | infinity | 0.210 | glass | 1.52 | 64.2 |
| 16 | | infinity | 0.500 | | | |
| 17 | Image plane | infinity | 0.000 | | | |

TABLE 8
Aspheric Coefficients

| surface | 2 | 3 | 5 | 6 | 7 | 8 |
|---|---|---|---|---|---|---|
| K: | 6.9250E+00 | −6.9058E+01 | 3.1482E−01 | −2.6512E+00 | −1.0366E+02 | −5.3291E+00 |
| A: | 0.0000E+00 | 0.0000E+00 | 0.0000E+00 | 0.0000E+00 | 0.0000E+00 | 0.0000E+00 |
| B: | 5.6241E−01 | 1.4225E+00 | 7.6228E−02 | −1.2490E−01 | −2.8346E−01 | −3.7908E−01 |
| C: | −7.9887E−01 | −2.8505E+00 | −3.2791E−01 | −1.7365E−01 | 4.8168E−01 | 7.6099E−01 |
| D: | 9.0274E−01 | 6.7255E+00 | 1.8517E+00 | 5.6860E−01 | −1.8939E+00 | −1.2677E+00 |
| E: | −7.1572E−01 | −9.5084E+00 | −7.2786E+00 | −1.9945E+00 | 3.5243E+00 | 1.2527E+00 |
| F: | 3.1661E−01 | 7.1952E+00 | 1.3191E+01 | 2.8771E+00 | −4.5812E+00 | −7.5682E−01 |
| G: | −5.7854E−02 | −1.8557E+00 | −1.0121E+01 | −1.6750E+00 | 2.4991E+00 | 2.1170E−01 |
| H: | 0.0000E+00 | 0.0000E+00 | 0.0000E+00 | 0.0000E+00 | 0.0000E+00 | 0.0000E+00 |
| surface | 9 | 10 | 11 | 12 | 13 | 14 |
| K: | −9.3055E+01 | −1.5919E−01 | −8.5748E+00 | −9.7738E−01 | −2.4202E+01 | −4.6715E+00 |
| A: | 0.0000E+00 | 0.0000E+00 | 0.0000E+00 | 0.0000E+00 | 0.0000E+00 | 0.0000E+00 |
| B: | −2.0498E−01 | 1.3043E−01 | 5.1364E−01 | 2.1835E−01 | −2.1194E−01 | −1.9841E−01 |
| C: | 2.8163E−02 | −1.2653E+00 | −1.3395E+00 | 1.3993E−01 | −8.1910E−02 | 1.1987E−01 |
| D: | 5.2982E−01 | 1.6206E+00 | 1.5924E+00 | −4.0017E−01 | 1.1155E−01 | −5.9810E−02 |
| E: | −8.2174E−01 | −9.3429E−01 | −1.1483E+00 | 3.2809E−01 | −8.5814E−02 | 1.9774E−02 |
| F: | 5.0422E−01 | 7.0140E−02 | 4.4571E−01 | −1.5501E−01 | 4.4538E−02 | −4.2806E−03 |
| G: | −1.1216E−01 | 1.8989E−01 | −7.3075E−02 | 4.2170E−02 | −1.0154E−02 | 5.6735E−04 |
| H: | 0.0000E+00 | −6.2462E−02 | 1.8935E−03 | −4.9211E−03 | 6.7792E−04 | −3.3385E−05 |

In the fourth embodiment, the equation of the aspheric surface profiles of the aforementioned lens elements is the same as the equation of the first embodiment. Also, the definitions of these parameters shown in the following table are the same as those stated in the first embodiment with corresponding values for the fourth embodiment, so an explanation in this regard will not be provided again.

Moreover, these parameters can be calculated from Table 7 and Table 8 as the following values and satisfy the following conditions:

Embodiment 4

| | | | |
|---|---|---|---|
| f[mm] | 2.01 | (CT4 + CT5)/CT3 | 4.731 |
| Fno | 2.11 | CT2/CT3 | 3.013 |
| FOV[deg.] | 119.99 | CT6/CT3 | 1.611 |
| (CT4 + CT5)/(CT1 + CT3 + CT6) | 1.318 | (CT4 + CT5)/CT1 | 4.832 |
| (CT1 + CT6)/CT3 | 2.590 | IMH/f23456 | 1.418 |
| f/f45 | 0.957 | IMH/f | 1.127 |
| f/f23456 | 1.258 | f/BFL | 1.811 |
| f3/f45 | −2.024 | CTSI/(IMH*2) | 0.999 |
| f6/f45 | −1.282 | | |

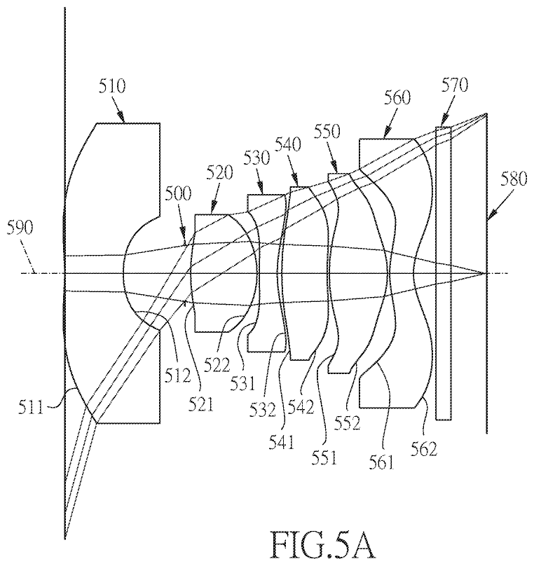

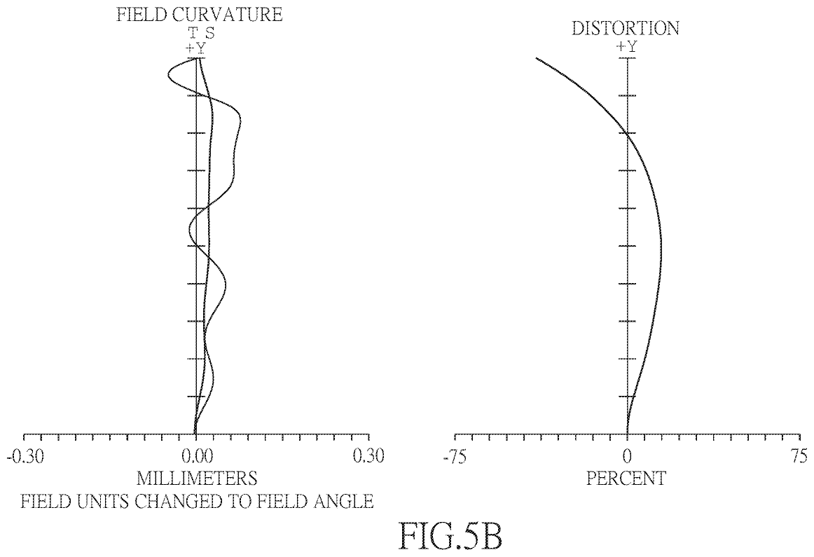

Referring to FIGS. 5A and 5B, FIG. 5A shows a six-piece optical lens system with a wide field of view in accordance with a fifth embodiment of the present invention, and FIG. 5B shows, in order from left to right, the image plane curve and the distortion curve of the fifth embodiment of the present invention. A six-piece optical lens system with a wide field of view in accordance with the fifth embodiment of the present invention comprises a stop 500 and a lens group. The lens group comprises, in order from an object side to an image side: a first lens element 510, a second lens element 520, a third lens element 530, a fourth lens element 540, a fifth lens element 550, a sixth lens element 560, an IR cut filter 570, and an image plane 580, wherein the six-piece optical lens system with a wide field of view has a total of six lens elements with refractive power. The stop 500 is disposed between the first lens element 510 and the second lens element 520.

The first lens element 510 with a negative refractive power has an object-side surface 511 being concave near an optical axis 590 and an image-side surface 512 being concave near the optical axis 590, the object-side surface 511 and the image-side surface 512 are aspheric, and the first lens element 510 is made of plastic material.

The second lens element 520 with a positive refractive power has an object-side surface 521 being convex near the optical axis 590 and an image-side surface 522 being convex near the optical axis 590, the object-side surface 521 and the image-side surface 522 are aspheric, and the second lens element 520 is made of plastic material.

The third lens element 530 with a negative refractive power has an object-side surface 531 being convex near the optical axis 590 and an image-side surface 532 being concave near the optical axis 590, the object-side surface 531 and the image-side surface 532 are aspheric, and the third lens element 530 is made of plastic material.

The fourth lens element 540 with a positive refractive power has an object-side surface 541 being convex near the optical axis 590 and an image-side surface 542 being concave near the optical axis 590, the object-side surface 541 and the image-side surface 542 are aspheric, and the fourth lens element 540 is made of plastic material.

The fifth lens element 550 with a positive refractive power has an object-side surface 551 being convex near the optical axis 590 and an image-side surface 552 being convex near the optical axis 590, the object-side surface 551 and the image-side surface 552 are aspheric, the fifth lens element 550 is made of plastic material, and the object-side surface 551 is provided with at least one inflection point.

The sixth lens element 560 with a negative refractive power has an object-side surface 561 being convex near the optical axis 590 and an image-side surface 562 being concave near the optical axis 590, the object-side surface 561 and the image-side surface 562 are aspheric and are provided with more than one inflection point, the sixth lens element 560 is made of plastic material.

The IR cut filter 570 made of glass is located between the sixth lens element 560 and the image plane 580 and has no influence on the focal length of the six-piece optical lens system with a wide field of view.

The detailed optical data of the fifth embodiment is shown in table 9, and the aspheric surface data is shown in table 10.

TABLE 9
Embodiment 5
f(focal length) = 1.01 mm, Fno = 2.03, FOV = 149.91 deg.

| surface | | Curvature Radius | | Thickness | Material | Index | Abbe # | Focal length |
|---|---|---|---|---|---|---|---|---|
| 0 | object | infinity | | 330.0 | | | | |
| 1 | test surface | infinity | | 0.000 | | | | |
| 2 | Lens 1 | −3.201 | (ASP) | 0.816 | plastic | 1.55 | 56.0 | −1.64 |
| 3 | | 1.358 | (ASP) | 0.858 | | | | |
| 4 | stop | infinity | | 0.081 | | | | |
| 5 | Lens 2 | 2.443 | (ASP) | 0.925 | plastic | 1.55 | 56.0 | 1.68 |
| 6 | | −1.273 | (ASP) | 0.031 | | | | |
| 7 | Lens 3 | 5.588 | (ASP) | 0.250 | plastic | 1.68 | 19.2 | −3.75 |
| 8 | | 1.716 | (ASP) | 0.065 | | | | |
| 9 | Lens 4 | 4.043 | (ASP) | 0.633 | plastic | 1.55 | 56.0 | 20.35 |
| 10 | | 6.006 | (ASP) | 0.030 | | | | |
| 11 | Lens 5 | 3.097 | (ASP) | 0.808 | plastic | 1.55 | 56.0 | 1.81 |
| 12 | | −1.318 | (ASP) | 0.030 | | | | |
| 13 | Lens 6 | 1.219 | (ASP) | 0.334 | plastic | 1.65 | 22.5 | −9.00 |
| 14 | | 0.900 | (ASP) | 0.313 | | | | |

| | | | | | | |
|---|---|---|---|---|---|---|
| 15 | IR-filter | infinity | 0.210 | glass | 1.52 | 64.2 |
| 16 | | infinity | 0.500 | | | |
| 17 | Image plane | infinity | 0.000 | | | |

TABLE 10
Aspheric Coefficients

| surface | 2 | 3 | 5 | 6 | 7 | 8 |
|---|---|---|---|---|---|---|
| K: | −1.4412E+02 | −1.2862E+01 | −5.9832E+00 | −8.4548E−01 | −2.6155E+02 | −3.6988E+00 |
| A: | 0.0000E+00 | 0.0000E+00 | 0.0000E+00 | 0.0000E+00 | 0.0000E+00 | 0.0000E+00 |
| B: | 1.0051E−01 | 1.2013E+00 | 1.4637E−01 | −4.9369E−01 | −5.6169E−01 | −3.0106E−01 |
| C: | −5.1778E−02 | −2.4133E+00 | −1.5644E+00 | 2.5889E+00 | 1.8786E+00 | 8.0217E−01 |
| D: | 2.0416E−02 | 5.7323E+00 | 7.3158E+00 | −8.3854E+00 | −6.0989E+00 | −1.8010E+00 |
| E: | −5.0707E−03 | −7.8569E+00 | −1.9268E+01 | 1.4135E+01 | 1.1196E+01 | 2.1671E+00 |
| F: | 6.9797E−04 | 7.0284E+00 | 2.1696E+01 | −1.3029E+01 | −1.1016E+01 | −1.2690E+00 |
| G: | −4.1020E−05 | −2.6434E+00 | −5.8920E+00 | 4.8621E+00 | 4.2750E+00 | 2.8016E−01 |
| H: | 0.0000E+00 | 0.0000E+00 | 0.0000E+00 | 0.0000E+00 | 0.0000E+00 | 0.0000E+00 |
| surface | 9 | 10 | 11 | 12 | 13 | 14 |
| K: | 9.9050E+00 | 2.1366E+01 | −1.5992E+01 | −6.1418E−01 | −1.2367E+01 | −2.5079E+00 |
| A: | 0.0000E+00 | 0.0000E+00 | 0.0000E+00 | 0.0000E+00 | 0.0000E+00 | 0.0000E+00 |
| B: | −1.8629E−01 | 7.3168E−02 | 4.5486E−01 | −3.0513E−01 | −2.8019E−01 | −1.1935E−01 |
| C: | 9.6685E−01 | −1.0606E+00 | −1.3880E+00 | 2.0512E+00 | 6.7996E−01 | −2.2169E−01 |
| D: | −2.2176E+00 | 1.7733E+00 | 2.5161E+00 | −3.3199E+00 | −1.5740E+00 | 3.2010E−01 |
| E: | 2.3397E+00 | −1.7302E+00 | −3.0676E+00 | 2.6137E+00 | 1.6484E+00 | −1.8661E−01 |
| F: | −1.1875E+00 | 1.0629E+00 | 2.1324E+00 | −1.1309E+00 | −8.7998E−01 | 5.6873E−02 |
| G: | 2.3128E−01 | −3.9577E−01 | −7.6188E−01 | 2.6149E−01 | 2.3554E−01 | −8.9253E−03 |
| H: | 0.0000E+00 | 6.9465E−02 | 1.0946E−01 | −2.5227E−02 | −2.4980E−02 | 5.6936E−04 |

In the fifth embodiment, the equation of the aspheric surface profiles of the aforementioned lens elements is the same as the equation of the first embodiment. Also, the definitions of these parameters shown in the following table are the same as those stated in the first embodiment with corresponding values for the fifth embodiment, so an explanation in this regard will not be provided again.

Moreover, these parameters can be calculated from Table 9 and Table 10 as the following values and satisfy the following conditions:

Embodiment 5

| | | | |
|---|---|---|---|
| f[mm] | 1.01 | (CT4 + CT5)/CT3 | 5.766 |
| Fno | 2.03 | CT2/CT3 | 3.701 |
| FOV[deg.] | 149.91 | CT6/CT3 | 1.337 |
| (CT4 + CT5)/(CT1 + CT3 + CT6) | 1.030 | (CT4 + CT5)/CT1 | 1.767 |
| (CT1 + CT6)/CT3 | 4.599 | IMH/f23456 | 1.593 |
| f/f45 | 0.566 | IMH/f | 2.244 |
| f/f23456 | 0.710 | f/BFL | 0.989 |
| f3/f45 | −2.100 | CTSI/(IMH*2) | 0.927 |
| f6/f45 | −5.032 | | |

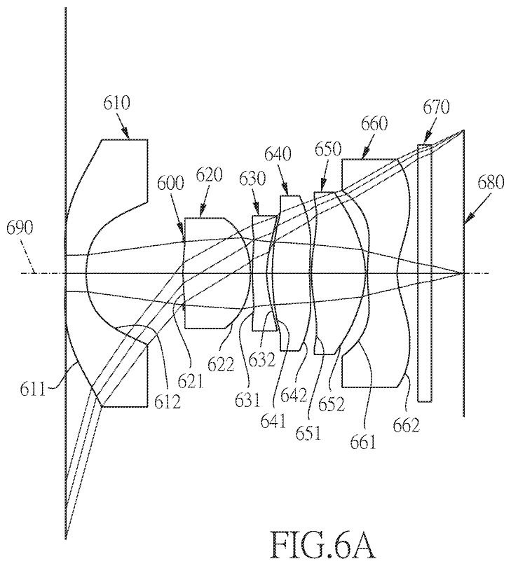

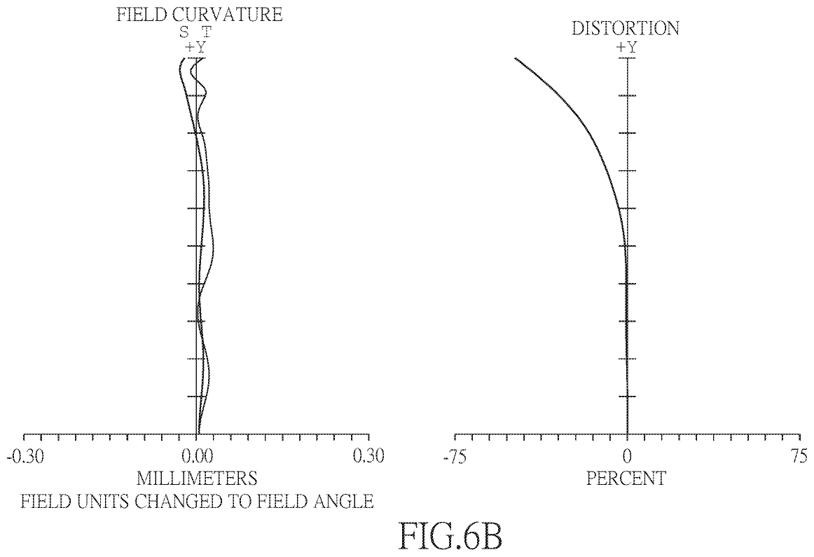

Referring to FIGS. 6A and 6B, FIG. 6A shows a six-piece optical lens system with a wide field of view in accordance with a sixth embodiment of the present invention, and FIG. 6B shows, in order from left to right, the image plane curve and the distortion curve of the sixth embodiment of the present invention. A six-piece optical lens system with a wide field of view in accordance with the sixth embodiment of the present invention comprises a stop 600 and a lens group. The lens group comprises, in order from an object side to an image side: a first lens element 610, a second lens element 620, a third lens element 630, a fourth lens element 640, a fifth lens element 650, a sixth lens element 660, an IR cut filter 670, and an image plane 680, wherein the six-piece optical lens system with a wide field of view has a total of six lens elements with refractive power. The stop 600 is disposed between the first lens element 610 and the second lens element 620.

The first lens element 610 with a negative refractive power has an object-side surface 611 being concave near an optical axis 690 and an image-side surface 612 being concave near the optical axis 690, the object-side surface 611 and the image-side surface 612 are aspheric, and the first lens element 610 is made of plastic material.

The second lens element 620 with a positive refractive power has an object-side surface 621 being convex near the optical axis 690 and an image-side surface 622 being convex near the optical axis 690, the object-side surface 621 and the image-side surface 622 are aspheric, and the second lens element 620 is made of plastic material.

The third lens element 630 with a negative refractive power has an object-side surface 631 being convex near the optical axis 690 and an image-side surface 632 being concave near the optical axis 690, the object-side surface 631 and the image-side surface 632 are aspheric, and the third lens element 630 is made of plastic material.

The fourth lens element 640 with a positive refractive power has an object-side surface 641 being convex near the optical axis 690 and an image-side surface 642 being concave near the optical axis 690, the object-side surface 641 and the image-side surface 642 are aspheric, and the fourth lens element 640 is made of plastic material.

The fifth lens element 650 with a positive refractive power has an object-side surface 651 being convex near the optical axis 690 and an image-side surface 652 being convex near the optical axis 690, the object-side surface 651 and the image-side surface 652 are aspheric, the fifth lens element 650 is made of plastic material, and the object-side surface 651 is provided with at least one inflection point.

The sixth lens element 660 with a negative refractive power has an object-side surface 661 being convex near the optical axis 690 and an image-side surface 662 being concave near the optical axis 690, the object-side surface 661 and the image-side surface 662 are aspheric and are provided with more than one inflection point, the sixth lens element 660 is made of plastic material.

The IR cut filter 670 made of glass is located between the sixth lens element 660 and the image plane 680 and has no influence on the focal length of the six-piece optical lens system with a wide field of view.

The detailed optical data of the sixth embodiment is shown in table 11, and the aspheric surface data is shown in table 12.

TABLE 11
Embodiment 6
f(focal length) = 1.19 mm, Fno = 2.06, FOV = 150.10 deg.

| surface | | Curvature Radius | | Thickness | Material | Index | Abbe # | Focal length |
|---|---|---|---|---|---|---|---|---|
| 0 | object | infinity | | 330.0 | | | | |
| 1 | test surface | infinity | | 0.000 | | | | |
| 2 | Lens 1 | −4.284 | (ASP) | 0.317 | plastic | 1.55 | 56.0 | −2.20 |
| 3 | | 1.707 | (ASP) | 1.507 | | | | |
| 4 | stop | infinity | | −0.005 | | | | |
| 5 | Lens 2 | 3.397 | (ASP) | 1.046 | plastic | 1.55 | 56.0 | 2.08 |
| 6 | | −1.516 | (ASP) | 0.030 | | | | |
| 7 | Lens 3 | 2.888 | (ASP) | 0.220 | plastic | 1.68 | 19.2 | −4.92 |
| 8 | | 1.499 | (ASP) | 0.088 | | | | |
| 9 | Lens 4 | 3.055 | (ASP) | 0.580 | plastic | 1.55 | 56.0 | 14.39 |
| 10 | | 4.665 | (ASP) | 0.031 | | | | |
| 11 | Lens 5 | 3.028 | (ASP) | 0.835 | plastic | 1.55 | 56.0 | 1.76 |
| 12 | | −1.267 | (ASP) | 0.031 | | | | |
| 13 | Lens 6 | 2.402 | (ASP) | 0.460 | plastic | 1.67 | 20.4 | −2.83 |
| 14 | | 0.976 | (ASP) | 0.322 | | | | |

| | | | | | | |
|---|---|---|---|---|---|---|
| 15 | IR-filter | infinity | 0.210 | glass | 1.52 | 64.2 |
| 16 | | infinity | 0.500 | | | |
| 17 | Image plane | infinity | 0.000 | | | |

TABLE 12
Aspheric Coefficients

| surface | 2 | 3 | 5 | 6 | 7 | 8 |
|---|---|---|---|---|---|---|
| K: | 1.7754E+00 | −2.3269E+01 | 1.9906E+00 | −1.4938E+00 | −3.3347E+01 | −4.9396E+00 |
| A: | 0.0000E+00 | 0.0000E+00 | 0.0000E+00 | 0.0000E+00 | 0.0000E+00 | 0.0000E+00 |
| B: | 3.1469E−01 | 9.0876E−01 | −3.4548E−02 | −3.1807E−01 | −1.1607E−01 | −5.3283E−02 |
| C: | −2.2131E−01 | −1.6471E+00 | −2.4236E+00 | −6.9436E−02 | −9.8370E−01 | −2.4467E−01 |
| D: | 1.0511E−01 | 4.8027E+00 | 3.6713E+01 | 1.1157E+00 | 2.9317E+00 | 5.5414E−01 |
| E: | −3.1821E−02 | −9.3166E+00 | −3.2539E+02 | −8.4406E−01 | −3.6373E+00 | −3.9457E−01 |
| F: | 5.8609E−03 | 1.0300E+01 | 1.6145E+03 | −3.4672E+00 | 2.1173E+00 | −1.5754E−02 |
| G: | −6.0185E−04 | −5.7726E+00 | −4.2014E+03 | 5.9190E+00 | −7.7600E−01 | 1.1956E−01 |
| H: | 2.6579E−05 | 1.2576E+00 | 4.4274E+03 | −2.7379E+00 | 2.5350E−01 | −3.6379E−02 |
| surface | 9 | 10 | 11 | 12 | 13 | 14 |
| K: | −2.9959E+01 | 8.7379E+00 | −8.4936E−01 | −5.1717E−01 | −4.6205E+01 | −6.8787E+00 |
| A: | 0.0000E+00 | 0.0000E+00 | 0.0000E+00 | 0.0000E+00 | 0.0000E+00 | 0.0000E+00 |
| B: | −1.5090E−01 | −1.4556E−01 | 1.0910E−01 | 1.1652E−01 | −2.0151E−01 | −2.7547E−02 |
| C: | 7.8940E−01 | −3.2416E−02 | −3.7805E−01 | 3.3907E−01 | 1.3052E−01 | −1.9175E−01 |
| D: | −1.5046E+00 | −1.2493E+00 | −1.5284E−01 | −7.2153E−01 | −6.9751E−01 | 2.2386E−01 |
| E: | 1.6405E+00 | 3.3923E+00 | 8.0815E−01 | 5.5280E−01 | 1.2255E+00 | −1.2004E−01 |
| F: | −1.0863E+00 | −3.4791E+00 | −6.7548E−01 | −1.8067E−01 | −9.7802E−01 | 3.4543E−02 |
| G: | 4.0586E−01 | 1.6053E+00 | 2.1733E−01 | 1.7209E−02 | 3.7283E−01 | −5.1782E−03 |
| H: | −6.5487E−02 | −2.7937E−01 | −2.2744E−02 | 1.7526E−03 | −5.5277E−02 | 3.1741E−04 |

In the sixth embodiment, the equation of the aspheric surface profiles of the aforementioned lens elements is the same as the equation of the first embodiment. Also, the definitions of these parameters shown in the following table are the same as those stated in the first embodiment with corresponding values for the sixth embodiment, so an explanation in this regard will not be provided again.

Moreover, these parameters can be calculated from Table 11 and Table 12 as the following values and satisfy the following conditions:

Embodiment 6

| | | | |
|---|---|---|---|
| f[mm] | 1.19 | (CT4 + CT5)/CT3 | 6.432 |
| Fno | 2.06 | CT2/CT3 | 4.754 |
| FOV[deg.] | 150.10 | CT6/CT3 | 2.093 |
| (CT4 + CT5)/(CT1 + CT3 + CT6) | 1.419 | (CT4 + CT5)/CT1 | 4.465 |
| (CT1 + CT6)/CT3 | 3.533 | IMH/f23456 | 1.477 |
| f/f45 | 0.693 | IMH/f | 1.909 |
| f/f23456 | 0.774 | f/BFL | 1.152 |
| f3/f45 | −2.868 | CTSI/(IMH*2) | 0.958 |
| f6/f45 | −1.650 | | |

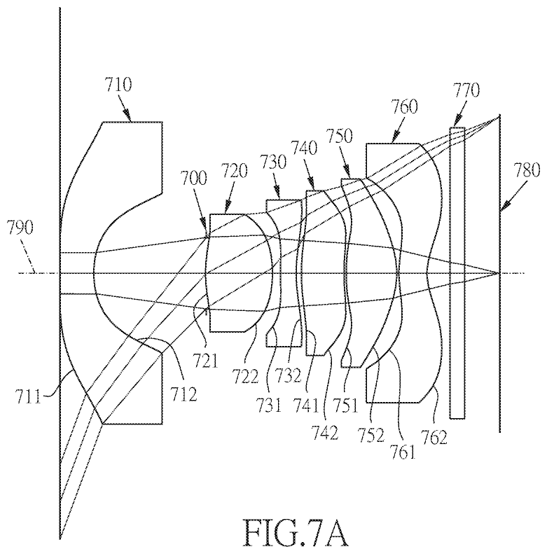

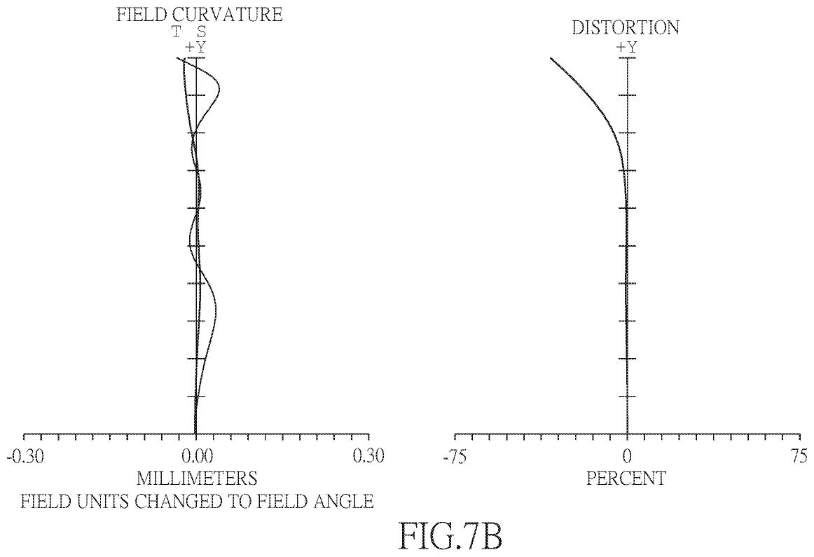

Referring to FIGS. 7A and 7B, FIG. 7A shows a six-piece optical lens system with a wide field of view in accordance with a seventh embodiment of the present invention, and FIG. 7B shows, in order from left to right, the image plane curve and the distortion curve of the seventh embodiment of the present invention. A six-piece optical lens system with a wide field of view in accordance with the seventh embodiment of the present invention comprises a stop 700 and a lens group. The lens group comprises, in order from an object side to an image side: a first lens element 710, a second lens element 720, a third lens element 730, a fourth lens element 740, a fifth lens element 750, a sixth lens element 760, an IR cut filter 770, and an image plane 780, wherein the six-piece optical lens system with a wide field of view has a total of six lens elements with refractive power. The stop 700 is disposed between the first lens element 710 and the second lens element 720.

The first lens element 710 with a negative refractive power has an object-side surface 711 being concave near an optical axis 790 and an image-side surface 712 being concave near the optical axis 790, the object-side surface 711 and the image-side surface 712 are aspheric, and the first lens element 710 is made of plastic material.

The second lens element 720 with a positive refractive power has an object-side surface 721 being convex near the optical axis 790 and an image-side surface 722 being convex near the optical axis 790, the object-side surface 721 and the image-side surface 722 are aspheric, and the second lens element 720 is made of plastic material.

The third lens element 730 with a negative refractive power has an object-side surface 731 being convex near the optical axis 790 and an image-side surface 732 being concave near the optical axis 790, the object-side surface 731 and the image-side surface 732 are aspheric, and the third lens element 730 is made of plastic material.

The fourth lens element 740 with a positive refractive power has an object-side surface 741 being convex near the optical axis 790 and an image-side surface 742 being concave near the optical axis 790, the object-side surface 741 and the image-side surface 742 are aspheric, and the fourth lens element 740 is made of plastic material.

The fifth lens element 750 with a positive refractive power has an object-side surface 751 being convex near the optical axis 790 and an image-side surface 752 being convex near the optical axis 790, the object-side surface 751 and the image-side surface 752 are aspheric, the fifth lens element 750 is made of plastic material, and the object-side surface 751 is provided with at least one inflection point.

The sixth lens element 760 with a negative refractive power has an object-side surface 761 being convex near the optical axis 790 and an image-side surface 762 being concave near the optical axis 790, the object-side surface 761 and the image-side surface 762 are aspheric and are provided with more than one inflection point, the sixth lens element 760 is made of plastic material.

The IR cut filter 770 made of glass is located between the sixth lens element 760 and the image plane 780 and has no influence on the focal length of the six-piece optical lens system with a wide field of view.

The detailed optical data of the seventh embodiment is shown in table 13, and the aspheric surface data is shown in table 14.

TABLE 13
Embodiment 7
f(focal length) = 1.24 mm, Fno = 2.06, FOV = 140.16 deg.

| surface | | Curvature Radius | | Thickness | Material | Index | Abbe # | Focal length |
|---|---|---|---|---|---|---|---|---|
| 0 | object | infinity | | 330.0 | | | | |
| 1 | test surface | infinity | | 0.000 | | | | |
| 2 | Lens 1 | −20.037 | (ASP) | 0.478 | plastic | 1.55 | 56.0 | −2.31 |
| 3 | | 1.354 | (ASP) | 1.602 | | | | |
| 4 | stop | infinity | | −0.009 | | | | |
| 5 | Lens 2 | 2.175 | (ASP) | 0.950 | plastic | 1.55 | 56.0 | 1.97 |
| 6 | | −1.794 | (ASP) | 0.117 | | | | |
| 7 | Lens 3 | 9.834 | (ASP) | 0.220 | plastic | 1.68 | 19.2 | −3.96 |
| 8 | | 2.087 | (ASP) | 0.076 | | | | |
| 9 | Lens 4 | 2.893 | (ASP) | 0.607 | plastic | 1.55 | 56.0 | 8.58 |
| 10 | | 7.011 | (ASP) | 0.030 | | | | |
| 11 | Lens 5 | 4.076 | (ASP) | 0.721 | plastic | 1.55 | 56.0 | 1.75 |
| 12 | | −1.174 | (ASP) | 0.030 | | | | |
| 13 | Lens 6 | 1.739 | (ASP) | 0.398 | plastic | 1.67 | 20.4 | −2.69 |
| 14 | | 0.802 | (ASP) | 0.328 | | | | |

| | | | | | | |
|---|---|---|---|---|---|---|
| 15 | IR-filter | infinity | 0.210 | glass | 1.52 | 64.2 |
| 16 | | infinity | 0.500 | | | |
| 17 | Image plane | infinity | 0.000 | | | |

TABLE 14
Aspheric Coefficients

| surface | 2 | 3 | 5 | 6 | 7 | 8 |
|---|---|---|---|---|---|---|
| K: | 2.2142E+00 | −5.9352E+00 | −2.4930E+00 | 3.8114E−01 | −3.2111E+02 | −4.2475E+00 |
| A: | 0.0000E+00 | 0.0000E+00 | 0.0000E+00 | 0.0000E+00 | 0.0000E+00 | 0.0000E+00 |
| B: | 1.3366E−01 | 4.4971E−01 | 2.3606E−03 | −1.5396E−01 | −2.7824E−01 | −1.9089E−01 |
| C: | −6.4837E−02 | −2.1972E−02 | −1.5514E+00 | −9.1834E−01 | −3.7510E−01 | 5.4981E−03 |
| D: | 2.3930E−02 | −2.9561E−01 | 1.5187E+01 | 3.5543E+00 | 1.2148E−02 | 3.3229E−01 |
| E: | −5.8126E−03 | 6.0373E−01 | −7.8581E+01 | −7.1935E+00 | 2.5549E+00 | −5.8265E−01 |
| F: | 7.6378E−04 | −4.0376E−01 | 1.9143E+02 | 7.0203E+00 | −5.0539E+00 | 4.2002E−01 |
| G: | −4.1144E−05 | 7.5372E−02 | −1.8222E+02 | −2.8999E+00 | 2.9366E+00 | −1.1144E−01 |
| H: | 0.0000E+00 | 0.0000E+00 | 0.0000E+00 | 0.0000E+00 | 0.0000E+00 | 0.0000E+00 |
| surface | 9 | 10 | 11 | 12 | 13 | 14 |
| K: | −1.1488E+01 | 1.1736E+01 | −1.2434E+00 | −8.5434E−01 | −1.6415E+01 | −4.5598E+00 |
| A: | 0.0000E+00 | 0.0000E+00 | 0.0000E+00 | 0.0000E+00 | 0.0000E+00 | 0.0000E+00 |
| B: | −1.0188E−01 | 5.1439E−01 | 6.8014E−01 | 2.6169E−01 | −1.9311E−01 | −2.2307E−01 |
| C: | 3.2997E−02 | −2.3395E+00 | −2.3026E+00 | −1.6006E−01 | −2.3726E−01 | 9.3688E−02 |
| D: | 4.3771E−01 | 2.7362E+00 | 3.2750E+00 | 2.3688E−01 | 3.0021E−01 | −6.4612E−03 |
| E: | −1.0734E+00 | −1.0636E+00 | −3.1960E+00 | −6.1001E−01 | −1.1201E−01 | −8.1820E−03 |
| F: | 8.8617E−01 | −4.8669E−01 | 2.1496E+00 | 6.5486E−01 | 7.1611E−03 | 2.1026E−03 |
| G: | −2.4670E−01 | 5.5331E−01 | −8.3144E−01 | −2.9896E−01 | −1.3544E−03 | −4.9944E−05 |
| H: | 0.0000E+00 | −1.3164E−01 | 1.3332E−01 | 4.9505E−02 | 1.5221E−03 | −2.0452E−05 |

In the seventh embodiment, the equation of the aspheric surface profiles of the aforementioned lens elements is the same as the equation of the first embodiment. Also, the definitions of these parameters shown in the following table are the same as those stated in the first embodiment with corresponding values for the seventh embodiment, so an explanation in this regard will not be provided again.

Moreover, these parameters can be calculated from Table 13 and Table 14 as the following values and satisfy the following conditions:

Embodiment 7

| | | | |
|---|---|---|---|
| f[mm] | 1.24 | (CT4 + CT5)/CT3 | 6.039 |
| Fno | 2.06 | CT2/CT3 | 4.320 |
| FOV[deg.] | 140.16 | CT6/CT3 | 1.809 |
| (CT4 + CT5)/(CT1 + CT3 + CT6) | 1.212 | (CT4 + CT5)/CT1 | 2.777 |
| (CT1 + CT6)/CT3 | 3.984 | IMH/f23456 | 1.454 |
| f/f45 | 0.762 | IMH/f | 1.838 |
| f/f23456 | 0.791 | f/BFL | 1.189 |
| f3/f45 | −2.442 | CTSI/(IMH*2) | 0.921 |
| f6/f45 | −1.660 | | |

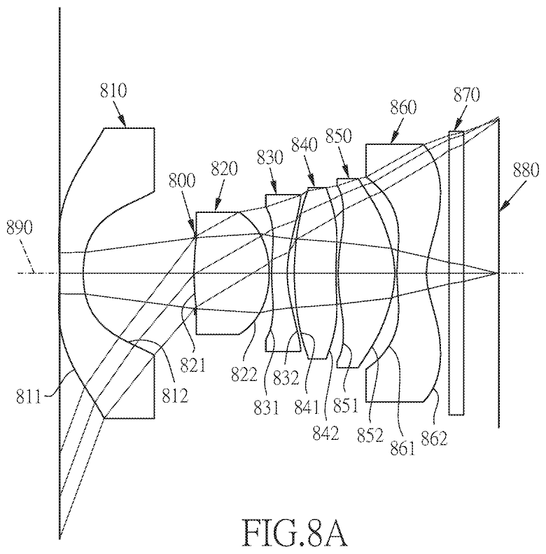

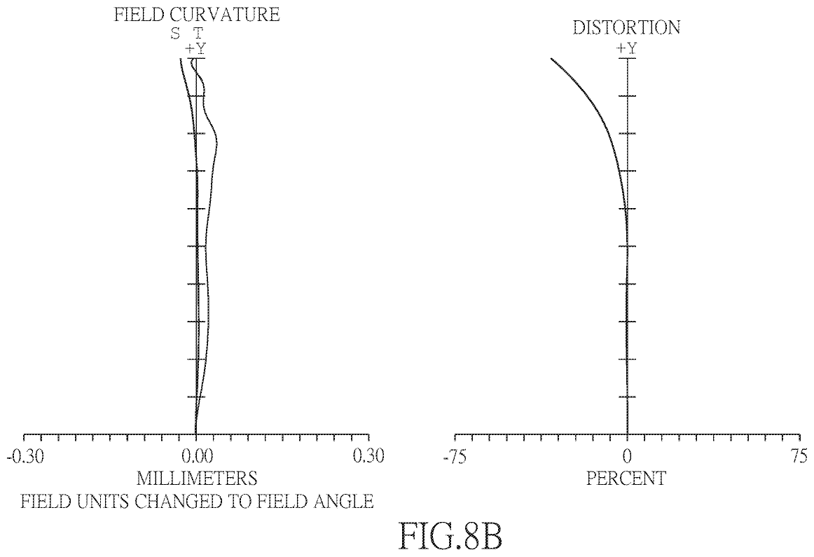

Referring to FIGS. 8A and 8B, FIG. 8A shows a six-piece optical lens system with a wide field of view in accordance with an eighth embodiment of the present invention, and FIG. 8B shows, in order from left to right, the image plane curve and the distortion curve of the eighth embodiment of the present invention. A six-piece optical lens system with a wide field of view in accordance with the eighth embodiment of the present invention comprises a stop 800 and a lens group. The lens group comprises, in order from an object side to an image side: a first lens element 810, a second lens element 820, a third lens element 830, a fourth lens element 840, a fifth lens element 850, a sixth lens element 860, an IR cut filter 870, and an image plane 880, wherein the six-piece optical lens system with a wide field of view has a total of six lens elements with refractive power. The stop 800 is disposed between the first lens element 810 and the second lens element 820.

The first lens element 810 with a negative refractive power has an object-side surface 811 being concave near an optical axis 890 and an image-side surface 812 being concave near the optical axis 890, the object-side surface 811 and the image-side surface 812 are aspheric, and the first lens element 810 is made of plastic material.

The second lens element 820 with a positive refractive power has an object-side surface 821 being convex near the optical axis 890 and an image-side surface 822 being convex near the optical axis 890, the object-side surface 821 and the image-side surface 822 are aspheric, and the second lens element 820 is made of plastic material.

The third lens element 830 with a negative refractive power has an object-side surface 831 being convex near the optical axis 890 and an image-side surface 832 being concave near the optical axis 890, the object-side surface 831 and the image-side surface 832 are aspheric, and the third lens element 830 is made of plastic material.

The fourth lens element 840 with a positive refractive power has an object-side surface 841 being convex near the optical axis 890 and an image-side surface 842 being concave near the optical axis 890, the object-side surface 841 and the image-side surface 842 are aspheric, and the fourth lens element 840 is made of plastic material.

The fifth lens element 850 with a positive refractive power has an object-side surface 851 being convex near the optical axis 890 and an image-side surface 852 being convex near the optical axis 890, the object-side surface 851 and the image-side surface 852 are aspheric, the fifth lens element 850 is made of plastic material, and the object-side surface 851 is provided with at least one inflection point.

The sixth lens element 860 with a negative refractive power has an object-side surface 861 being convex near the optical axis 890 and an image-side surface 862 being concave near the optical axis 890, the object-side surface 861 and the image-side surface 862 are aspheric and are provided with more than one inflection point, the sixth lens element 860 is made of plastic material.

The IR cut filter 870 made of glass is located between the sixth lens element 860 and the image plane 880 and has no influence on the focal length of the six-piece optical lens system with a wide field of view.

The detailed optical data of the eighth embodiment is shown in table 15, and the aspheric surface data is shown in table 16.

TABLE 15
Embodiment 8
f(focal length) = 1.23 mm, Fno = 2.06, FOV = 140.14 deg.

| surface | | Curvature Radius | | Thickness | Material | Index | Abbe # | Focal length |
|---|---|---|---|---|---|---|---|---|
| 0 | object | infinity | | 330.0 | | | | |
| 1 | test surface | infinity | | 0.000 | | | | |
| 2 | Lens 1 | −4.550 | (ASP) | 0.338 | plastic | 1.55 | 56.0 | −2.37 |
| 3 | | 1.859 | (ASP) | 1.591 | | | | |
| 4 | stop | infinity | | −0.012 | | | | |
| 5 | Lens 2 | 3.211 | (ASP) | 1.072 | plastic | 1.55 | 56.0 | 2.08 |
| 6 | | −1.544 | (ASP) | 0.034 | | | | |
| 7 | Lens 3 | 3.178 | (ASP) | 0.223 | plastic | 1.68 | 19.2 | −5.25 |
| 8 | | 1.629 | (ASP) | 0.099 | | | | |
| 9 | Lens 4 | 3.390 | (ASP) | 0.595 | plastic | 1.55 | 56.0 | 17.12 |
| 10 | | 4.989 | (ASP) | 0.032 | | | | |
| 11 | Lens 5 | 2.760 | (ASP) | 0.807 | plastic | 1.55 | 56.0 | 1.77 |
| 12 | | −1.338 | (ASP) | 0.031 | | | | |
| 13 | Lens 6 | 2.467 | (ASP) | 0.419 | plastic | 1.67 | 20.4 | −2.70 |
| 14 | | 0.969 | (ASP) | 0.324 | | | | |

| | | | | | | |
|---|---|---|---|---|---|---|
| 15 | IR-filter | infinity | 0.210 | glass | 1.52 | 64.2 |
| 16 | | infinity | 0.500 | | | |
| 17 | Image plane | infinity | 0.000 | | | |

TABLE 16
Aspheric Coefficients

| surface | 2 | 3 | 5 | 6 | 7 | 8 |
|---|---|---|---|---|---|---|
| K: | 1.5303E+00 | −2.4820E+01 | 8.8699E−01 | −1.2164E+00 | −3.4622E+01 | −4.9624E+00 |
| A: | 0.0000E+00 | 0.0000E+00 | 0.0000E+00 | 0.0000E+00 | 0.0000E+00 | 0.0000E+00 |
| B: | 3.0995E−01 | 7.9969E−01 | −3.8265E−02 | −2.9679E−01 | −1.7744E−01 | −7.9754E−02 |
| C: | −2.1259E−01 | −1.0574E+00 | −2.1286E+00 | −2.6500E−01 | −4.2401E−01 | −1.0732E−01 |
| D: | 9.8721E−02 | 2.6996E+00 | 2.7615E+01 | 2.7020E+00 | 1.2310E+00 | 4.2201E−01 |
| E: | −2.8915E−02 | −5.1546E+00 | −2.1196E+02 | −8.0258E+00 | −1.2594E+00 | −5.6669E−01 |
| F: | 5.0810E−03 | 5.6577E+00 | 9.1612E+02 | 1.1791E+01 | 2.9054E−01 | 4.1575E−01 |
| G: | −4.9132E−04 | −3.0953E+00 | −2.1013E+03 | −9.1349E+00 | 1.8474E−01 | −1.7524E−01 |
| H: | 2.0057E−05 | 6.4634E−01 | 1.9741E+03 | 2.9035E+00 | −5.3201E−02 | 3.1989E−02 |
| surface | 9 | 10 | 11 | 12 | 13 | 14 |
| K: | −3.6101E+01 | 9.3886E+00 | −2.8028E+00 | −4.8370E−01 | −4.7786E+01 | −7.1132E+00 |
| A: | 0.0000E+00 | 0.0000E+00 | 0.0000E+00 | 0.0000E+00 | 0.0000E+00 | 0.0000E+00 |
| B: | −9.9805E−02 | −1.2515E−01 | 5.5180E−02 | 1.5308E−01 | −2.1168E−01 | −7.3615E−02 |
| C: | 3.9940E−01 | −1.1173E−01 | −2.2976E−01 | 1.5563E−01 | 2.6045E−02 | −6.8795E−02 |
| D: | −3.7649E−01 | −7.5154E−01 | −3.5816E−01 | −3.8421E−01 | −1.0347E−01 | 1.0763E−01 |
| E: | −7.9609E−02 | 2.3180E+00 | 9.7660E−01 | 1.8029E−01 | 2.4773E−01 | −6.2741E−02 |
| F: | 3.7332E−01 | −2.4385E+00 | −7.7814E−01 | 7.1018E−02 | −2.1482E−01 | 1.8629E−02 |
| G: | −2.3862E−01 | 1.1329E+00 | 2.6359E−01 | −7.5938E−02 | 8.1351E−02 | −2.8115E−03 |
| H: | 5.0128E−02 | −1.9657E−01 | −3.2396E−02 | 1.5861E−02 | −1.1421E−02 | 1.7040E−04 |

In the eighth embodiment, the equation of the aspheric surface profiles of the aforementioned lens elements is the same as the equation of the first embodiment. Also, the definitions of these parameters shown in the following table are the same as those stated in the first embodiment with corresponding values for the eighth embodiment, so an explanation in this regard will not be provided again.

Moreover, these parameters can be calculated from Table 15 and Table 16 as the following values and satisfy the following conditions:

Embodiment 8

| | | | |
|---|---|---|---|
| f[mm] | 1.23 | (CT4 + CT5)/CT3 | 6.299 |
| Fno | 2.06 | CT2/CT3 | 4.818 |
| FOV[deg.] | 140.14 | CT6/CT3 | 1.883 |
| (CT4 + CT5)/(CT1 + CT3 + CT6) | 1.431 | (CT4 + CT5)/CT1 | 4.143 |
| (CT1 + CT6)/CT3 | 3.403 | IMH/f23456 | 1.445 |
| f/f45 | 0.706 | IMH/f | 1.845 |
| f/f23456 | 0.783 | f/BFL | 1.190 |
| f3/f45 | −3.009 | CTSI/(IMH*2) | 0.955 |
| f6/f45 | −1.546 | | |

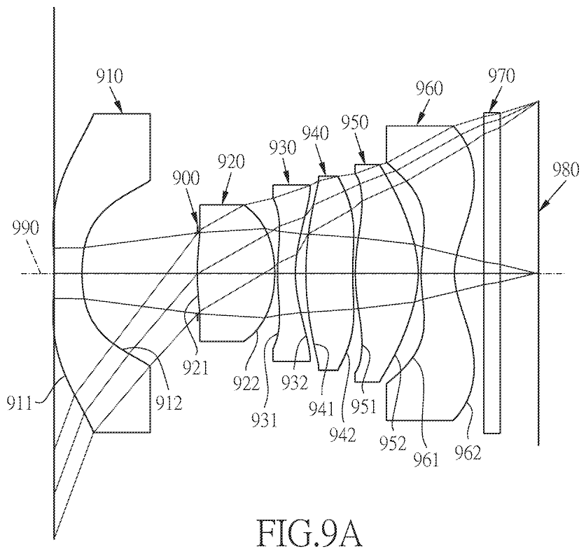

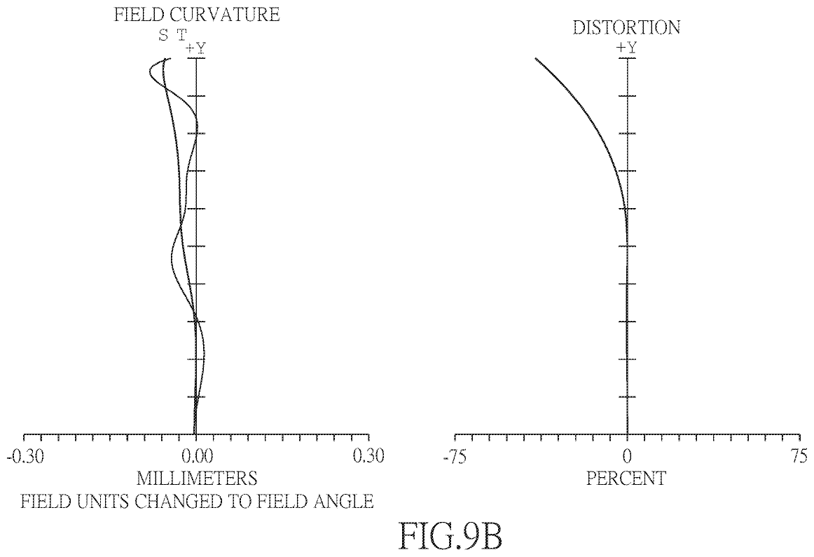

Referring to FIGS. 9A and 9B, FIG. 9A shows a six-piece optical lens system with a wide field of view in accordance with a ninth embodiment of the present invention, and FIG. 9B shows, in order from left to right, the image plane curve and the distortion curve of the ninth embodiment of the present invention. A six-piece optical lens system with a wide field of view in accordance with the ninth embodiment of the present invention comprises a stop 900 and a lens group. The lens group comprises, in order from an object side to an image side: a first lens element 910, a second lens element 920, a third lens element 930, a fourth lens element 940, a fifth lens element 950, a sixth lens element 960, an IR cut filter 970, and an image plane 980, wherein the six-piece optical lens system with a wide field of view has a total of six lens elements with refractive power. The stop 900 is disposed between the first lens element 910 and the second lens element 920.

The first lens element 910 with a negative refractive power has an object-side surface 911 being concave near an optical axis 990 and an image-side surface 912 being concave near the optical axis 990, the object-side surface 911 and the image-side surface 912 are aspheric, and the first lens element 910 is made of plastic material.

The second lens element 920 with a positive refractive power has an object-side surface 921 being convex near the optical axis 990 and an image-side surface 922 being convex near the optical axis 990, the object-side surface 921 and the image-side surface 922 are aspheric, and the second lens element 920 is made of plastic material.

The third lens element 930 with a negative refractive power has an object-side surface 931 being convex near the optical axis 990 and an image-side surface 932 being concave near the optical axis 990, the object-side surface 931 and the image-side surface 932 are aspheric, and the third lens element 930 is made of plastic material.

The fourth lens element 940 with a positive refractive power has an object-side surface 941 being convex near the optical axis 990 and an image-side surface 942 being concave near the optical axis 990, the object-side surface 941 and the image-side surface 942 are aspheric, and the fourth lens element 940 is made of plastic material.

The fifth lens element 950 with a positive refractive power has an object-side surface 951 being convex near the optical axis 990 and an image-side surface 952 being convex near the optical axis 990, the object-side surface 951 and the image-side surface 952 are aspheric, the fifth lens element 950 is made of plastic material, and the object-side surface 951 is provided with at least one inflection point.

The sixth lens element 960 with a negative refractive power has an object-side surface 961 being convex near the optical axis 990 and an image-side surface 962 being concave near the optical axis 990, the object-side surface 961 and the image-side surface 962 are aspheric and are provided with more than one inflection point, the sixth lens element 960 is made of plastic material.

The IR cut filter 970 made of glass is located between the sixth lens element 960 and the image plane 980 and has no influence on the focal length of the six-piece optical lens system with a wide field of view.

The detailed optical data of the ninth embodiment is shown in table 17, and the aspheric surface data is shown in table 18.

TABLE 17
Embodiment 9
f(focal length) = 1.37 mm, Fno = 2.06, FOV = 140.04 deg.

| surface | | Curvature Radius | | Thickness | Material | Index | Abbe # | Focal length |
|---|---|---|---|---|---|---|---|---|
| 0 | object | infinity | | 400.0 | | | | |
| 1 | test surface | infinity | | 0.000 | | | | |
| 2 | Lens 1 | −4.564 | (ASP) | 0.362 | plastic | 1.55 | 56.0 | −2.70 |
| 3 | | 2.246 | (ASP) | 1.497 | | | | |
| 4 | stop | infinity | | −0.006 | | | | |
| 5 | Lens 2 | 3.239 | (ASP) | 1.002 | plastic | 1.54 | 55.6 | 2.29 |
| 6 | | −1.769 | (ASP) | 0.036 | | | | |
| 7 | Lens 3 | 3.007 | (ASP) | 0.232 | plastic | 1.68 | 19.2 | −5.62 |
| 8 | | 1.628 | (ASP) | 0.134 | | | | |
| 9 | Lens 4 | 3.408 | (ASP) | 0.609 | plastic | 1.55 | 56.0 | 14.62 |
| 10 | | 5.570 | (ASP) | 0.033 | | | | |
| 11 | Lens 5 | 2.747 | (ASP) | 0.814 | plastic | 1.54 | 55.6 | 1.87 |
| 12 | | −1.418 | (ASP) | 0.037 | | | | |
| 13 | Lens 6 | 2.041 | (ASP) | 0.430 | plastic | 1.67 | 20.4 | −2.98 |
| 14 | | 0.922 | (ASP) | 0.381 | | | | |

| | | | | | | |
|---|---|---|---|---|---|---|
| 15 | IR-filter | infinity | 0.210 | glass | 1.52 | 64.2 |
| 16 | | infinity | 0.500 | | | |
| 17 | Image plane | infinity | 0.000 | | | |

TABLE 18
Aspheric Coefficients

| surface | 2 | 3 | 5 | 6 | 7 | 8 |
|---|---|---|---|---|---|---|
| K: | 1.8426E+00 | −3.0114E+01 | −7.6458E−01 | −8.2970E−01 | −2.9995E+01 | −4.9152E+00 |
| A: | 0.0000E+00 | 0.0000E+00 | 0.0000E+00 | 0.0000E+00 | 0.0000E+00 | 0.0000E+00 |
| B: | 2.4441E−01 | 5.8466E−01 | −1.1209E−01 | −3.1496E−01 | −1.8381E−01 | −9.6123E−02 |
| C: | −1.4297E−01 | −6.3343E−01 | −4.8270E−01 | 7.1081E−01 | 1.4704E−01 | 8.5340E−02 |
| D: | 5.9840E−02 | 1.3647E+00 | 5.8706E+00 | −2.8251E+00 | −1.0106E+00 | −2.0385E−01 |
| E: | −1.6617E−02 | −2.2053E+00 | −2.4544E+01 | 6.8329E+00 | 2.8793E+00 | 4.1758E−01 |
| F: | 2.8591E−03 | 2.1150E+00 | 1.1019E+01 | −9.5377E+00 | −3.7916E+00 | −4.2765E−01 |
| G: | −2.7708E−04 | −1.0403E+00 | 1.2340E+02 | 6.7695E+00 | 2.3538E+00 | 2.0537E−01 |
| H: | 1.1559E−05 | 1.9742E−01 | −1.9016E+02 | −1.9496E+00 | −5.6444E−01 | −3.9174E−02 |
| surface | 9 | 10 | 11 | 12 | 13 | 14 |
| K: | −2.8228E+01 | 8.9239E+00 | −3.3095E+00 | −5.0195E−01 | −1.9052E+01 | −5.1168E+00 |
| A: | 0.0000E+00 | 0.0000E+00 | 0.0000E+00 | 0.0000E+00 | 0.0000E+00 | 0.0000E+00 |
| B: | −3.9877E−02 | −7.2478E−02 | 3.7990E−02 | 1.2099E−01 | −2.2025E−01 | −7.8229E−02 |
| C: | 1.6645E−01 | −2.8006E−01 | −1.7241E−01 | 1.9787E−01 | 1.5499E−01 | −2.6877E−02 |
| D: | −1.5448E−01 | −1.4104E−01 | −3.1552E−01 | −5.1460E−01 | −4.3420E−01 | 4.3433E−02 |
| E: | 2.0671E−02 | 1.0596E+00 | 8.5825E−01 | 4.9495E−01 | 5.8598E−01 | −2.2531E−02 |
| F: | 4.5261E−02 | −1.1735E+00 | −7.3873E−01 | −2.4320E−01 | −3.8707E−01 | 6.0131E−03 |
| G: | −2.5744E−02 | 5.2987E−01 | 2.8722E−01 | 6.1171E−02 | 1.2529E−01 | −8.3368E−04 |
| H: | 4.0918E−03 | −8.7191E−02 | −4.3636E−02 | −6.2630E−03 | −1.5870E−02 | 4.7019E−05 |

In the ninth embodiment, the equation of the aspheric surface profiles of the aforementioned lens elements is the same as the equation of the first embodiment. Also, the definitions of these parameters shown in the following table are the same as those stated in the first embodiment with corresponding values for the ninth embodiment, so an explanation in this regard will not be provided again.

Moreover, these parameters can be calculated from Table 17 and Table 18 as the following values and satisfy the following conditions:

Embodiment 9

| | | | |
|---|---|---|---|
| f[mm] | 1.37 | (CT4 + CT5)/CT3 | 6.146 |
| Fno | 2.06 | CT2/CT3 | 4.329 |
| FOV[deg.] | 140.04 | CT6/CT3 | 1.859 |
| (CT4 + CT5)/(CT1 + CT3 + CT6) | 1.389 | (CT4 + CT5)/CT1 | 3.928 |
| (CT1 + CT6)/CT3 | 3.424 | IMH/f23456 | 1.391 |
| f/f45 | 0.761 | IMH/f | 1.654 |
| f/f23456 | 0.841 | f/BFL | 1.258 |
| f3/f45 | −3.118 | CTSI/(IMH*2) | 0.972 |
| f6/f45 | −1.652 | | |

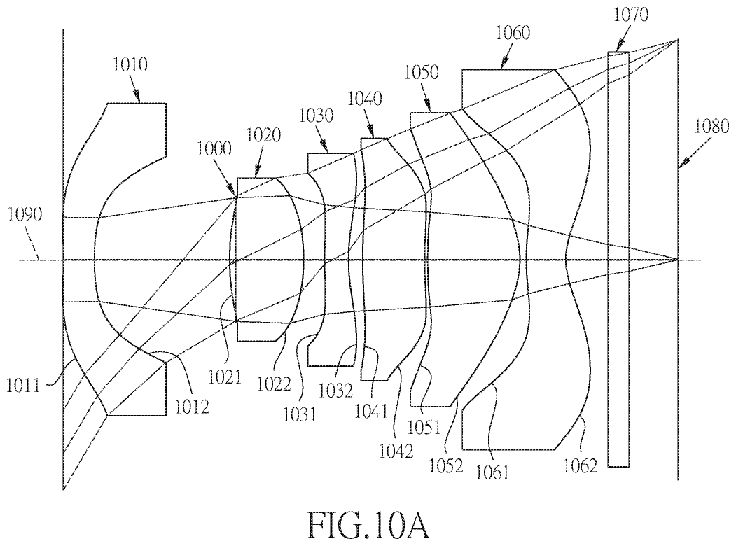

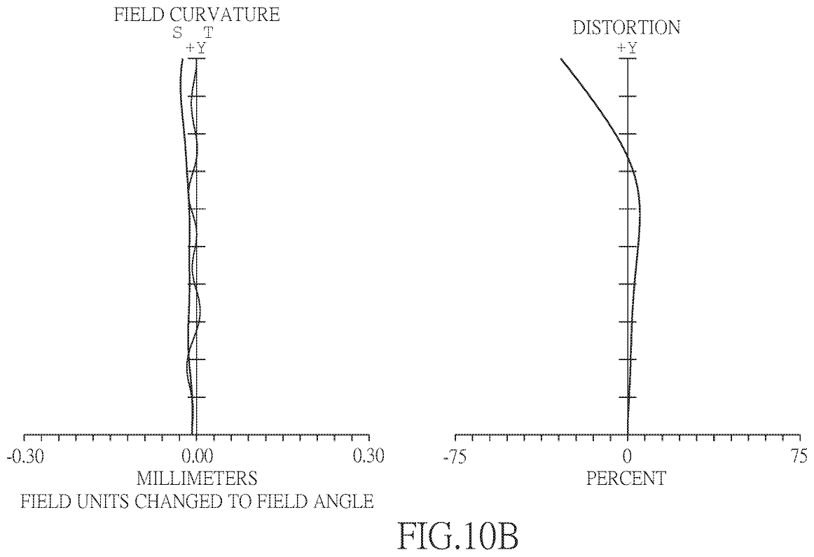

Referring to FIGS. 10A and 10B, FIG. 10A shows a six-piece optical lens system with a wide field of view in accordance with a tenth embodiment of the present invention, and FIG. 10B shows, in order from left to right, the image plane curve and the distortion curve of the tenth embodiment of the present invention. A six-piece optical lens system with a wide field of view in accordance with the tenth embodiment of the present invention comprises a stop 1000 and a lens group. The lens group comprises, in order from an object side to an image side: a first lens element 1010, a second lens element 1020, a third lens element 1030, a fourth lens element 1040, a fifth lens element 1050, a sixth lens element 1060, an IR cut filter 1070, and an image plane 1080, wherein the six-piece optical lens system with a wide field of view has a total of six lens elements with refractive power. The stop 1000 is disposed between the first lens element 1010 and the second lens element 1020.

The first lens element 1010 with a negative refractive power has an object-side surface 1011 being concave near an optical axis 1090 and an image-side surface 1012 being concave near the optical axis 1090, the object-side surface 1011 and the image-side surface 1012 are aspheric, and the first lens element 1010 is made of plastic material.

The second lens element 1020 with a positive refractive power has an object-side surface 1021 being convex near the optical axis 1090 and an image-side surface 1022 being convex near the optical axis 1090, the object-side surface 1021 and the image-side surface 1022 are aspheric, and the second lens element 1020 is made of plastic material.

The third lens element 1030 with a negative refractive power has an object-side surface 1031 being convex near the optical axis 1090 and an image-side surface 1032 being concave near the optical axis 1090, the object-side surface 1031 and the image-side surface 1032 are aspheric, and the third lens element 1030 is made of plastic material.

The fourth lens element 1040 with a positive refractive power has an object-side surface 1041 being convex near the optical axis 1090 and an image-side surface 1042 being concave near the optical axis 1090, the object-side surface 1041 and the image-side surface 1042 are aspheric, and the fourth lens element 1040 is made of plastic material.

The fifth lens element 1050 with a positive refractive power has an object-side surface 1051 being convex near the optical axis 1090 and an image-side surface 1052 being convex near the optical axis 1090, the object-side surface 1051 and the image-side surface 1052 are aspheric, the fifth lens element 1050 is made of plastic material, and the object-side surface 1051 is provided with at least one inflection point.

The sixth lens element 1060 with a negative refractive power has an object-side surface 1061 being convex near the optical axis 1090 and an image-side surface 1062 being concave near the optical axis 1090, the object-side surface 1061 and the image-side surface 1062 are aspheric and are provided with more than one inflection point, the sixth lens element 1060 is made of plastic material.

The IR cut filter 1070 made of glass is located between the sixth lens element 1060 and the image plane 1080 and has no influence on the focal length of the six-piece optical lens system with a wide field of view.

The detailed optical data of the tenth embodiment is shown in table 19, and the aspheric surface data is shown in table 20.

TABLE 19
Embodiment 10
f(focal length) = 1.85 mm, Fno = 2.06, FOV = 119.82 deg.

| surface | | Curvature Radius | | Thickness | Material | Index | Abbe # | Focal length |
|---|---|---|---|---|---|---|---|---|
| 0 | object | infinity | | 1.0E+08 | | | | |
| 1 | test surface | infinity | | 0.000 | | | | |
| 2 | Lens 1 | −5.956 | (ASP) | 0.313 | plastic | 1.55 | 56.0 | −3.57 |
| 3 | | 2.951 | (ASP) | 1.427 | | | | |
| 4 | stop | infinity | | −0.060 | | | | |
| 5 | Lens 2 | 2.455 | (ASP) | 0.750 | plastic | 1.55 | 56.0 | 2.09 |
| 6 | | −1.900 | (ASP) | 0.213 | | | | |
| 7 | Lens 3 | 4.927 | (ASP) | 0.240 | plastic | 1.65 | 22.5 | −4.66 |
| 8 | | 1.836 | (ASP) | 0.145 | | | | |
| 9 | Lens 4 | 5.689 | (ASP) | 0.626 | plastic | 1.55 | 56.0 | 19.24 |
| 10 | | 11.915 | (ASP) | 0.030 | | | | |
| 11 | Lens 5 | 11.807 | (ASP) | 0.932 | plastic | 1.55 | 56.0 | 1.68 |
| 12 | | −0.967 | (ASP) | 0.064 | | | | |
| 13 | Lens 6 | 1.887 | (ASP) | 0.400 | plastic | 1.65 | 22.5 | −1.96 |
| 14 | | 0.696 | (ASP) | 0.430 | | | | |

| | | | | | | |
|---|---|---|---|---|---|---|
| 15 | IR-filter | infinity | 0.210 | glass | 1.52 | 64.2 |
| 16 | | infinity | 0.500 | | | |
| 17 | Image plane | infinity | 0.000 | | | |

TABLE 20
Aspheric Coefficients

| surface | 2 | 3 | 5 | 6 | 7 | 8 |
|---|---|---|---|---|---|---|
| K: | 7.8389E−01 | −9.0000E+01 | 1.1918E+00 | −3.9940E+00 | −8.9825E+01 | −5.6346E+00 |
| A: | 0.0000E+00 | 0.0000E+00 | 0.0000E+00 | 0.0000E+00 | 0.0000E+00 | 0.0000E+00 |
| B: | 3.8451E−01 | 8.0338E−01 | −3.6399E−02 | −1.4019E−01 | −2.9915E−01 | −2.7192E−01 |
| C: | −3.3771E−01 | −8.1912E−01 | 2.0394E−01 | −1.2421E−01 | 1.6861E−01 | 4.1482E−01 |
| D: | 2.3869E−01 | 8.8256E−01 | −1.4632E+00 | 4.3636E−01 | −6.9804E−01 | −5.3519E−01 |
| E: | −1.0619E−01 | −3.8703E−01 | 3.4908E+00 | −1.4818E+00 | 9.7170E−01 | 2.3787E−01 |
| F: | 2.4210E−02 | 9.8648E−02 | −4.1926E+00 | 2.0101E+00 | −1.0244E+00 | 8.1231E−02 |
| G: | −2.1955E−03 | −5.9264E−02 | 1.1780E+00 | −1.1818E+00 | 5.4461E−01 | −6.9236E−02 |
| H: | 0.0000E+00 | 0.0000E+00 | 0.0000E+00 | 0.0000E+00 | 0.0000E+00 | 0.0000E+00 |
| surface | 9 | 10 | 11 | 12 | 13 | 14 |
| K: | −9.9441E+01 | −3.6768E−02 | −9.9766E−02 | −1.0650E+00 | −3.2055E+01 | −4.7799E+00 |
| A: | 0.0000E+00 | 0.0000E+00 | 0.0000E+00 | 0.0000E+00 | 0.0000E+00 | 0.0000E+00 |
| B: | −5.4391E−02 | 5.2421E−01 | 7.1792E−01 | 3.2689E−01 | −2.1401E−01 | −2.1164E−01 |
| C: | −8.2491E−02 | −2.3166E+00 | −2.3806E+00 | −2.3772E−01 | −3.7272E−02 | 1.4636E−01 |
| D: | 6.2021E−01 | 2.6458E+00 | 2.8927E+00 | 5.0930E−03 | −2.7664E−02 | −7.7552E−02 |
| E: | −1.2674E+00 | −1.0912E+00 | −1.9614E+00 | 9.3166E−02 | 1.1572E−01 | 2.7337E−02 |
| F: | 1.0196E+00 | −3.0182E−01 | 8.3819E−01 | −4.4863E−02 | −8.6226E−02 | −6.3891E−03 |
| G: | −2.8723E−01 | 4.1767E−01 | −2.2020E−01 | 4.7904E−03 | 2.7638E−02 | 8.8141E−04 |
| H: | 0.0000E+00 | −1.0134E−01 | 2.7026E−02 | 6.0804E−04 | −3.2784E−03 | −5.1723E−05 |

In the tenth embodiment, the equation of the aspheric surface profiles of the aforementioned lens elements is the same as the equation of the first embodiment. Also, the definitions of these parameters shown in the following table are the same as those stated in the first embodiment with corresponding values for the tenth embodiment, so an explanation in this regard will not be provided again.

Moreover, these parameters can be calculated from Table 19 and Table 20 as the following values and satisfy the following conditions:

Embodiment 10

| | | | |
|---|---|---|---|
| f[mm] | 1.85 | (CT4 + CT5)/CT3 | 6.492 |
| Fno | 2.06 | CT2/CT3 | 3.125 |
| FOV[deg.] | 119.82 | CT6/CT3 | 1.667 |
| (CT4 + CT5)/(CT1 + CT3 + CT6) | 1.635 | (CT4 + CT5)/CT1 | 4.978 |
| (CT1 + CT6)/CT3 | 2.971 | IMH/f23456 | 1.246 |
| f/f45 | 1.120 | IMH/f | 1.227 |
| f/f23456 | 1.016 | f/BFL | 1.623 |
| f3/f45 | −2.823 | CTSI/(IMH*2) | 0.987 |
| f6/f45 | −1.187 | | |

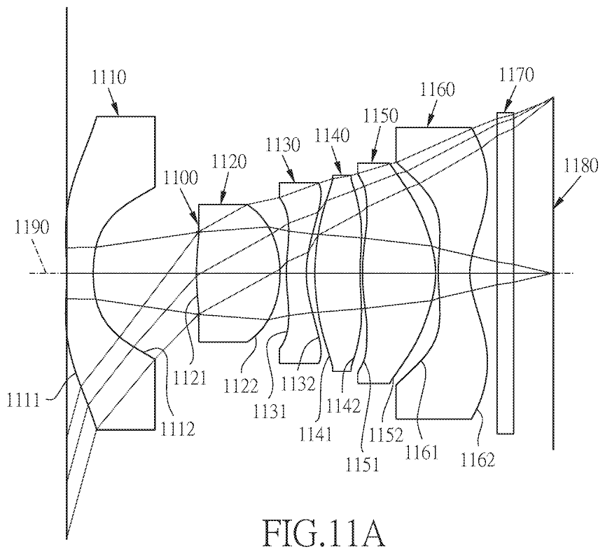

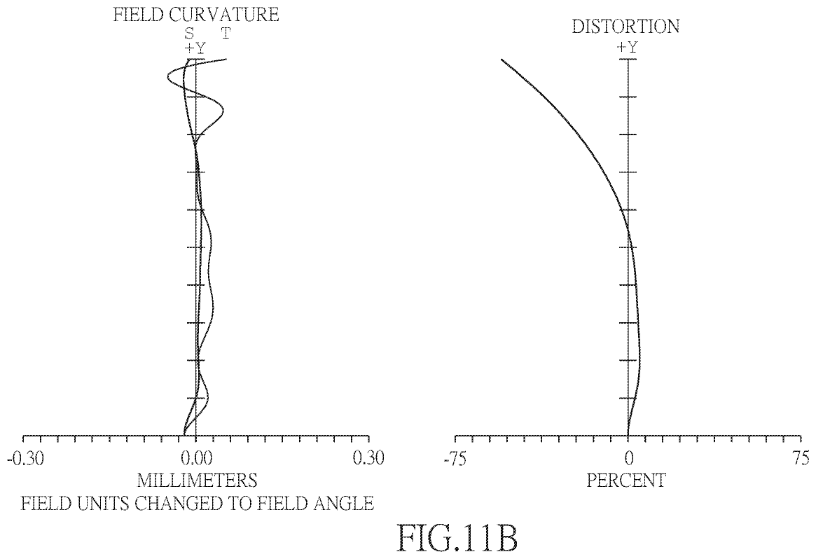

Referring to FIGS. 11A and 11B, FIG. 11A shows a six-piece optical lens system with a wide field of view in accordance with an eleventh embodiment of the present invention, and FIG. 11B shows, in order from left to right, the image plane curve and the distortion curve of the eleventh embodiment of the present invention. A six-piece optical lens system with a wide field of view in accordance with the eleventh embodiment of the present invention comprises a stop 1100 and a lens group. The lens group comprises, in order from an object side to an image side: a first lens element 1110, a second lens element 1120, a third lens element 1130, a fourth lens element 1140, a fifth lens element 1150, a sixth lens element 1160, an IR cut filter 1170, and an image plane 1180, wherein the six-piece optical lens system with a wide field of view has a total of six lens elements with refractive power. The stop 1100 is disposed between the first lens element 1110 and the second lens element 1120.

The first lens element 1110 with a negative refractive power has an object-side surface 1111 being concave near an optical axis 1190 and an image-side surface 1112 being concave near the optical axis 1190, the object-side surface 1111 and the image-side surface 1112 are aspheric, and the first lens element 1110 is made of plastic material.

The second lens element 1120 with a positive refractive power has an object-side surface 1121 being convex near the optical axis 1190 and an image-side surface 1122 being convex near the optical axis 1190, the object-side surface 1121 and the image-side surface 1122 are aspheric, and the second lens element 1120 is made of plastic material.

The third lens element 1130 with a negative refractive power has an object-side surface 1131 being convex near the optical axis 1190 and an image-side surface 1132 being concave near the optical axis 1190, the object-side surface 1131 and the image-side surface 1132 are aspheric, and the third lens element 1130 is made of plastic material.

The fourth lens element 1140 with a positive refractive power has an object-side surface 1141 being convex near the optical axis 1190 and an image-side surface 1142 being concave near the optical axis 1190, the object-side surface 1141 and the image-side surface 1142 are aspheric, and the fourth lens element 1140 is made of plastic material.

The fifth lens element 1150 with a positive refractive power has an object-side surface 1151 being convex near the optical axis 1190 and an image-side surface 1152 being convex near the optical axis 1190, the object-side surface 1151 and the image-side surface 1152 are aspheric, the fifth lens element 1150 is made of plastic material, and the object-side surface 1151 is provided with at least one inflection point.

The sixth lens element 1160 with a negative refractive power has an object-side surface 1161 being convex near the optical axis 1190 and an image-side surface 1162 being concave near the optical axis 1190, the object-side surface 1161 and the image-side surface 1162 are aspheric and are provided with more than one inflection point, the sixth lens element 1160 is made of plastic material.

The IR cut filter 1170 made of glass is located between the sixth lens element 1160 and the image plane 1180 and has no influence on the focal length of the six-piece optical lens system with a wide field of view.

The detailed optical data of the eleventh embodiment is shown in table 21, and the aspheric surface data is shown in table 22.

TABLE 21
Embodiment 11
f(focal length) = 1.35 mm, Fno = 2.06, FOV = 149.87 deg.

| surface | | Curvature Radius | | Thickness | Material | Index | Abbe # | Focal length |
|---|---|---|---|---|---|---|---|---|
| 0 | object | infinity | | 1.0E+08 | | | | |
| 1 | test surface | infinity | | 0.000 | | | | |
| 2 | Lens 1 | −3.904 | (ASP) | 0.334 | plastic | 1.55 | 56.0 | −2.27 |
| 3 | | 1.868 | (ASP) | 1.335 | | | | |
| 4 | stop | infinity | | −0.026 | | | | |
| 5 | Lens 2 | 3.388 | (ASP) | 1.058 | plastic | 1.55 | 56.0 | 2.13 |
| 6 | | −1.571 | (ASP) | 0.081 | | | | |
| 7 | Lens 3 | 2.359 | (ASP) | 0.250 | plastic | 1.65 | 22.5 | −5.24 |
| 8 | | 1.334 | (ASP) | 0.109 | | | | |
| 9 | Lens 4 | 2.504 | (ASP) | 0.574 | plastic | 1.55 | 56.0 | 10.32 |
| 10 | | 4.139 | (ASP) | 0.030 | | | | |
| 11 | Lens 5 | 3.250 | (ASP) | 0.927 | plastic | 1.55 | 56.0 | 1.74 |
| 12 | | −1.211 | (ASP) | 0.030 | | | | |
| 13 | Lens 6 | 2.095 | (ASP) | 0.400 | plastic | 1.68 | 19.2 | −2.32 |
| 14 | | 0.829 | (ASP) | 0.347 | | | | |

| | | | | | | |
|---|---|---|---|---|---|---|
| 15 | IR-filter | infinity | 0.210 | glass | 1.52 | 64.2 |
| 16 | | infinity | 0.500 | | | |
| 17 | Image plane | infinity | 0.000 | | | |

TABLE 22
Aspheric Coefficients

| surface | 2 | 3 | 5 | 6 | 7 | 8 |
|---|---|---|---|---|---|---|
| K: | 2.1686E+00 | −6.8306E+01 | 5.3612E+00 | −1.8381E+00 | −2.3447E+01 | −4.8082E+00 |
| A: | 0.0000E+00 | 0.0000E+00 | 0.0000E+00 | 0.0000E+00 | 0.0000E+00 | 0.0000E+00 |
| B: | 3.3115E−01 | 1.0519E+00 | −2.4875E−02 | −2.1202E−01 | −8.6631E−02 | −8.7999E−02 |
| C: | −2.6079E−01 | −2.0478E+00 | −2.3923E+00 | −1.4698E+00 | −1.5349E+00 | −1.5939E−01 |
| D: | 1.4177E−01 | 5.0199E+00 | 3.1182E+01 | 8.7999E+00 | 5.7975E+00 | 6.2362E−01 |
| E: | −4.9932E−02 | −9.0654E+00 | −2.3535E+02 | −2.3694E+01 | −1.0936E+01 | −9.2960E−01 |
| F: | 1.0844E−02 | 1.0108E+01 | 9.7850E+02 | 3.3719E+01 | 1.1673E+01 | 7.5644E−01 |
| G: | −1.3262E−03 | −5.9660E+00 | −2.1153E+03 | −2.5053E+01 | −7.0343E+00 | −3.6081E−01 |
| H: | 7.0775E−05 | 1.3987E+00 | 1.8478E+03 | 7.6030E+00 | 1.8879E+00 | 7.5847E−02 |
| surface | 9 | 10 | 11 | 12 | 13 | 14 |
| K: | −2.4992E+01 | 9.3345E+00 | −4.4491E−01 | −5.0483E−01 | −8.9951E+01 | −6.3612E+00 |
| A: | 0.0000E+00 | 0.0000E+00 | 0.0000E+00 | 0.0000E+00 | 0.0000E+00 | 0.0000E+00 |
| B: | −1.3805E−01 | −1.5080E−01 | 9.7360E−02 | 1.7508E−01 | −1.7270E−01 | −1.1570E−01 |
| C: | 8.8219E−01 | −6.9362E−02 | −3.3374E−01 | 4.3406E−01 | −7.5434E−02 | 3.4112E−02 |
| D: | −1.9195E+00 | −1.3610E+00 | −7.9823E−01 | −1.1774E+00 | 1.4312E−01 | 1.3494E−03 |
| E: | 2.3656E+00 | 4.0171E+00 | 2.3787E+00 | 1.1045E+00 | −2.4458E−01 | −1.1234E−02 |
| F: | −1.7266E+00 | −4.3775E+00 | −2.2108E+00 | −4.6933E−01 | 2.3082E−01 | 6.5034E−03 |
| G: | 6.9404E−01 | 2.1372E+00 | 8.8455E−01 | 8.1876E−02 | −9.6876E−02 | −1.5630E−03 |
| H: | −1.1883E−01 | −3.9351E−01 | −1.2920E−01 | −2.5359E−03 | 1.4929E−02 | 1.3824E−04 |

In the eleventh embodiment, the equation of the aspheric surface profiles of the aforementioned lens elements is the same as the equation of the first embodiment. Also, the definitions of these parameters shown in the following table are the same as those stated in the first embodiment with corresponding values for the eleventh embodiment, so an explanation in this regard will not be provided again.

Moreover, these parameters can be calculated from Table 21 and Table 22 as the following values and satisfy the following conditions:

Embodiment 11

| | | | |
|---|---|---|---|
| f[mm] | 1.35 | (CT4 + CT5)/CT3 | 6.007 |
| Fno | 2.06 | CT2/CT3 | 4.231 |
| FOV[deg.] | 149.87 | CT6/CT3 | 1.600 |
| (CT4 + CT5)/(CT1 + CT3 + CT6) | 1.526 | (CT4 + CT5)/CT1 | 4.497 |
| (CT1 + CT6)/CT3 | 2.936 | IMH/f23456 | 1.461 |
| f/f45 | 0.805 | IMH/f | 1.682 |
| f/f23456 | 0.869 | f/BFL | 1.277 |
| f3/f45 | −3.125 | CTSI/(IMH*2) | 0.989 |
| f6/f45 | −1.383 | | |

In the present six-piece optical lens system with a wide field of view, the lens elements can be made of plastic or glass. If the lens elements are made of plastic, the cost will be effectively reduced. If the lens elements are made of glass, there is more freedom in distributing the refractive power of the six-piece optical lens system with a wide field of view. Plastic lens elements can have aspheric surfaces, which allow more design parameter freedom (than spherical surfaces), so as to reduce the aberration and the number of the lens elements, as well as the total track length of the six-piece optical lens system with a wide field of view.

In the present six-piece optical lens system with a wide field of view, if the object-side or the image-side surface of the lens elements with refractive power is convex and the location of the convex surface is not defined, the object-side or the image-side surface of the lens elements near the optical axis is convex. If the object-side or the image-side surface of the lens elements is concave and the location of the concave surface is not defined, the object-side or the image-side surface of the lens elements near the optical axis is concave.

The six-piece optical lens system with a wide field of view of the present invention can be used in focusing optical systems and can obtain better image quality. The six-piece optical lens system with a wide field of view of the present invention can also be used in electronic imaging systems, such as, 3D image capturing, digital camera, mobile device, digital flat panel or vehicle camera.

While we have shown and described various embodiments in accordance with the present invention, it should be clear to those skilled in the art that further embodiments may be made without departing from the scope of the present invention.

What is claimed is:

1. A six-piece optical lens system with a wide field of view, comprising a stop and a lens group having six lens elements, in order from an object side to an image side, comprising:
a first lens element with a negative refractive power, having an object-side surface being concave near an optical axis and an image-side surface being concave near the optical axis, at least one of the object-side surface and the image-side surface of the first lens element being aspheric;
the stop;
a second lens element with a positive refractive power, having an object-side surface being convex near the optical axis and an image-side surface being convex near the optical axis, at least one of the object-side surface and the image-side surface of the second lens element being aspheric;
a third lens element with a negative refractive power, having an object-side surface being convex near the optical axis and an image-side surface being concave near the optical axis, at least one of the object-side surface and the image-side surface of the third lens element being aspheric;
a fourth lens element with a positive refractive power, having an object-side surface being convex near the optical axis and an image-side surface being concave near the optical axis, at least one of the object-side surface and the image-side surface of the fourth lens element being aspheric;
a fifth lens element with a positive refractive power, having an object-side surface being convex near the optical axis and an image-side surface being convex near the optical axis, at least one of the object-side surface and the image-side surface of the fifth lens element being aspheric and provided with at least one inflection point; and
a sixth lens element with a negative refractive power, having an object-side surface being convex near the optical axis and an image-side surface being concave near the optical axis, at least one of the object-side surface and the image-side surface of the sixth lens element being aspheric and provided with at least one inflection point;
wherein a central thickness of the first lens element along the optical axis is CT1, a central thickness of the third lens element along the optical axis is CT3, a central thickness of the fourth lens element along the optical axis is CT4, a central thickness of the fifth lens element along the optical axis is CTS, a central thickness of the sixth lens element along the optical axis is CT6, and they satisfy the relations: 0.82<(CT4+CT5)/(CT1+CT3+CT6)<1.96; 2.07<(CT1+CT6)/CT3<5.52.

2. The six-piece optical lens system with a wide field of view as claimed in claim 1, wherein a focal length of the six-piece optical lens system with a wide field of view is f, a focal length of the fourth lens element and the fifth lens element combined is f45, and they satisfy the relation: 0.45<f/f45<1.34.

3. The six-piece optical lens system with a wide field of view as claimed in claim 1, wherein a focal length of the second lens element, the third lens element, the fourth lens element, the fifth lens element and the sixth lens element combined is f23456, a focal length of the six-piece optical lens system with a wide field of view is f, and they satisfy the relation: 0.56<f/f23456<1.51.

4. The six-piece optical lens system with a wide field of view as claimed in claim 1, wherein a focal length of the third lens element is f3, a focal length of the fourth lens element and the fifth lens element combined is f45, and they satisfy the relation: −3.75<f3/f45<−1.62.

5. The six-piece optical lens system with a wide field of view as claimed in claim 1, wherein a focal length of the fourth lens element and the fifth lens element combined is f45, a focal length of the sixth lens element is f6, and they satisfy the relation: −6.04<f6/f45<−0.95.

6. The six-piece optical lens system with a wide field of view as claimed in claim 1, wherein the central thickness of the fourth lens element along the optical axis is CT4, the central thickness of the fifth lens element along the optical axis is CTS, the central thickness of the third lens element along the optical axis is CT3, and they satisfy the relation: 3.78<(CT4+CT5)/CT3<8.38.

7. The six-piece optical lens system with a wide field of view as claimed in claim 1, wherein a central thickness of the second lens element along the optical axis is CT2, the central thickness of the third lens element along the optical axis is CT3, and they satisfy the relation: 2.41<CT2/CT3<5.78.

8. The six-piece optical lens system with a wide field of view as claimed in claim 1, wherein the central thickness of the sixth lens element along the optical axis is CT6, the central thickness of the third lens element along the optical axis is CT3, and they satisfy the relation: 1.07<CT6/CT3<2.86.

9. The six-piece optical lens system with a wide field of view as claimed in claim 1, wherein the central thickness of the fourth lens element along the optical axis is CT4, the central thickness of the fifth lens element along the optical axis is CT5, the central thickness of the first lens element along the optical axis is CT1, and they satisfy the relation: 1.41<(CT4+CT5)/CT1<7.4.

10. The six-piece optical lens system with a wide field of view as claimed in claim 1, wherein a focal length of the second lens element, the third lens element, the fourth lens element, the fifth lens element and the sixth lens element combined is f23456, half of an image height that can be captured by the six-piece optical lens system with a wide field of view on an image plane is IMH, and they satisfy the relation: 0.99<IMH/f23456<1.98.

11. The six-piece optical lens system with a wide field of view as claimed in claim 1, wherein a focal length of the six-piece optical lens system with a wide field of view is f, half of an image height that can be captured by the six-piece optical lens system with a wide field of view on an image plane is IMH, and they satisfy the relation: 0.9<IMH/f<2.69.

12. The six-piece optical lens system with a wide field of view as claimed in claim 1, wherein a distance from the image-side surface of the sixth lens element to an image plane along the optical axis is BFL, a focal length of the six-piece optical lens system with a wide field of view is f, and they satisfy the relation: 0.79<f/BFL<2.17.

13. The six-piece optical lens system with a wide field of view as claimed in claim 1, wherein half of an image height that can be captured by the six-piece optical lens system with a wide field of view on an image plane is IMH, a distance from the stop to the image plane along the optical axis is CTSI, and they satisfy the relation: 0.73<CTSI/(IMH*2)<1.2.
